(19) United States
(12) Patent Application Publication
(10) Pub. No.: US 2026/0087529 A1
(43) Pub. Date: Mar. 26, 2026

(54) ACQUISITION GUIDANCE SYSTEM FOR RENT PREDICTION AND MAX PROFIT VALUE ADDITION

(71) Applicant: Integrated Property Technology, LLC, Oro Valley, AZ (US)

(72) Inventor: Brandon B. Matheson, Tucson, AZ (US)

(21) Appl. No.: 19/405,092

(22) Filed: Dec. 1, 2025

Related U.S. Application Data
(63) Continuation-in-part of application No. 18/679,224, filed on May 30, 2024.
(60) Provisional application No. 63/505,017, filed on May 30, 2023.

(51) Int. Cl. G06Q 30/02; G06Q 40/03; G06Q 50/163

(52) U.S. Cl. CPC G06Q 30/0278; G06Q 40/03055; G06Q 50/163

(57) ABSTRACT

A method for calculating and displaying an explainable financial value prediction and predicted income property valuation metrics of a subject property including one or more subject units by isolating and quantifying the effects of a plurality of financial value value components including location, size, operational characteristics, online reputation characteristics, age, and one or more physical features on financial values and property valuation metrics. The method includes quantifying an effect of adding physical features, operational characteristics and online reputation characteristics on financial value and property valuation metrics for a plurality of properties. The method further includes sorting, filtering and stratifying properties according to predicted income property valuation metrics.

### CROSS-REFERENCES TO RELATED APPLICATIONS

This application is a continuation-in-part and claims benefit of U.S. Non-Provisional application Ser. No. 18/679,224 filed May 30, 2024, which is a non-provisional and claims benefit of U.S. Provisional Application No. 63/505,017 filed May 30, 2023, the specification of which are incorporated herein in their entirety by reference.

### FIELD OF THE INVENTION

The present disclosed invention relates to a semi-automatic method for performing as-is and as-if valuations of real estate that integrates machine learning and human input.

### BACKGROUND OF THE INVENTION

Real estate makes up a substantial portion of worldwide asset value; this includes commercial property, residential property, government buildings and raw land. A significant portion of that real estate is being sold or leased, or being considered for sale, purchase or lease at any given time. Any time a party considers the purchase, sale, lease, financing, insurance or taxation of real property, each potential party to the transaction typically must make a calculation as to the value of the real property at hand. The valuation of property can be complex due to the many factors that impact real estate value, including specific characteristics of the property, the location of the property and potential uses of and improvements to the property.

A real estate investor, broker, lender, developer or other investment real estate professional may desire to use an income-based approach of evaluation to calculate certain investment metrics and to determine the suitability of one or more income-producing real properties for investment. Likewise, a governmental agency or non-profit organization interested in promoting affordable housing may desire to quantify the difference between investment values of rental properties renting units at market rental rates versus renting units at below-market rental rates in order to quantify the gap that must be filled by public funding. Manual valuation and automated evaluation models are two common existing approaches used to evaluate real estate with unique advantages and disadvantages for each. There is a sharp divide between these two approaches.

Manual valuation approaches consider qualitative aspects of properties, incorporate the judgement of the evaluator, and can include as-if valuations that take into consideration contemplated improvements. However, manual valuations are also slow, typically taking hours for one, subjective in the selection of comparable transactions and economic adjustments to those transaction prices, and cumbersome in requiring the manual collection of information from many different sources. A manual property evaluation allows the evaluator to take into consideration the condition of the subject property as well as each of the comparable properties.

One of the more time consuming aspects of manual valuation is the search for and selection of comparable sales (or rentals) to use to derive a value for the subject property. While it is easy to filter for quantitative characteristics like size, age, sale or rental listing date and distance within a database of properties, there is not an easy way to filter properties by condition, such as whether and to what degree the property has been recently updated or is outdated, which directly affects the value of the property.

Instead, the evaluator typically must filter by quantitative characteristics first, and then manually scan through and inspect many photo images of many properties in order to subjectively decide which ones to use as comparable transactions, and then make subjective economic adjustments for the differences in condition between each comparable transaction and the subject property. This manual inspection process has drawbacks in time and subjectivity, but it does give the human evaluator the opportunity to exclude from the basis of the evaluation properties or transactions with characteristics that make them incomparable to the subject property, that would otherwise not be measured or identified by a machine-automated valuation process. In some situations, manual valuations face sparse data limitations where there are an insufficient number of recent comparable transactions with similar quantitative and qualitative property characteristics for the evaluator to use to make a defensible value estimate.

Auto valuation models, or AVMs, on the other hand, are very fast and efficient, typically providing evaluations instantly. However, what they gain in speed, they lack in transparency, qualitative judgement and input, human oversight and the opportunity to create as-if scenarios. AVMs tend to be black boxes that do not explain how they come to the value conclusions they do, making it more difficult for users to trust their output. They do not give the user the opportunity to “peek under the hood” to understand the basis for the AVM's conclusion.

AVMs often fail to take into consideration qualitative characteristics of properties. Since qualitative aspects comprise a large portion of a property's value, AVMs are forced to fit their models to the random noise associated with the missing qualitative inputs. This severely limits the potential accuracy of a model. Models that do collect and take into consideration qualitative aspects do not typically share that information with the user, adding to the opacity problem. This also makes an AVM useless in terms of helping a manual evaluator find comparable transactions. Even if AVMs were not so opaque, they still lack the opportunity for human input. There are still many value-impacting aspects of a property that a machine cannot know, but a human can. Yet, without the opportunity for a user to inspect, understand and adjust or exclude input, the AVM will still generate incorrect output.

AVMs also don't typically generate as-if improved valuations. The after repair value is a critical metric for investors and their appraisers and lenders. They also do not allow the user to change the qualitative characteristics of the subject property to create and fine tune an as-if improved evaluation. Furthermore, AVMs do not typically track or communicate the relative influence of discrete value-adding factors throughout the modeling process. This compounds the unexplainability factor and also hinders any opportunity for the user to see the potential impact of contemplated improvements to a property.

### BRIEF SUMMARY OF THE INVENTION

It is an objective of the present invention to provide systems and methods that allow for an automated method for accurately determining a value of a property or rental rate of a rental unit in view of past and potential improvements and added value, as specified in the independent claims. Embodiments of the invention are given in the dependent claims. Embodiments of the present invention can be freely combined with each other if they are not mutually exclusive.

This invention provides a computer-implemented method for generating explainable predictions of rental rates or property values by decomposing the influence of individual value components. The method uses rental and sales comparable transactions, processor-performed regression, and regression of residuals to transform raw property characteristics into normalized, separable predictors that can be easily explained in human terms and applied consistently across single-unit properties, multi-unit properties, or properties of any type that have comparable transactions.

The system begins by selecting a group of comparable properties relevant to the subject property. Each comparable property includes at least two units or transactions that differ in one or more characteristics such as size, physical features, age, operational attributes, online reputation, or location. These differences allow the system to isolate and quantify the effect of specific value drivers. The method does not depend on the comparable properties being multi-unit buildings; the comparable units may be individual properties, individual sales, or individual rental units.

To isolate the impact of size, the system identifies comparable properties or comparable transactions that differ in size while being similar in other key attributes. For these comparable units or transactions, the system performs processor-based regression between transaction price (or rent) and size to model the size relationship. The resulting best-fit equations for each comparable group are combined into a weighted average size curve representing the effect of size on rental rate or property value for the subject property.

To isolate the contribution of physical features, the system selects comparable properties that are similar in size and location but differ in interior or exterior characteristics. Each comparable unit or transaction is assigned a set of feature values and feature weights based on the quality and estimated importance of the features. These are aggregated into an Appeal Quality Scale (AQS) score. Differences in AQS scores and corresponding differences in actual rental rates or sales prices are automatically quantified by a processor to estimate how much value is contributed by the full range of physical condition, from fully outdated to fully updated. This generates a General AQS Value used to compute the feature-based adjustment for the subject property.

To quantify the effect of location, the system predicts an intermediate value for each comparable using the isolated size and feature components. The difference between this prediction and the actual rental rate or sales price is stored as a residual representing the location contribution. These residuals are associated with the coordinates of each comparable and may be supplemented with geographic, demographic, economic, or proximity-based data. Spatial modeling approaches such as kriging or inverse-distance weighting are used to estimate the effect of location on value.

After isolating size, features, and location, the system applies adjustments to each comparable unit or transaction to align it with the subject property across the quantified components. The adjusted comparable values are averaged to generate the predicted rental rate or predicted property value. Users may include or exclude comparables or apply manual adjustments, and the system recomputes the prediction accordingly.

The system also provides a full valuation pipeline when needed. Predicted rental rates or predicted values can be used to calculate gross rents, effective gross income, operating expenses, property taxes, insurance, payroll, utilities, repairs and maintenance, management fees, and other expense categories. The system computes net operating income, loan size and terms, debt service, and a range of valuation and investment metrics utilizing system-generated or optionally user-input values such as gross rent multiplier, capitalization rate, operating expense ratio, loan-to-value ratio, debt service coverage ratio, yield on cost, internal rate of return, and cashflow.

Comparable properties can be sorted and ranked by similarity to the subject based on the magnitude of component adjustments, and can be displayed in tabular or geographic form with labels indicating classification tiers.

The invention proposed here provides a solution to the problems above and others via the incorporation of an Appeal Quality Scale (AQS). The AQS quantifies the qualitative characteristics of real property that substantially impact the value of the property or rental rate of the rental unit in the eyes of the paying buyer or lessee so that these qualitative characteristics can be incorporated as input into an AVM to produce significantly superior accuracy in the modeling, estimation, and prediction of real estate rental rates and property values. In particular, the AQS allows an AVM to easily distinguish the extent to which older properties have been updated or renovated based upon specific discrete attributes indicative of the properties' renovation status and overall appeal quality, to measure the impact of various combinations of improvements on property values and unit rental rates from a large data set of properties, to measure how closely improvements to a property align with the characteristics valuable to a typical end user, and to systematically adjust the predicted values or rental rates of properties accordingly.

The AQS is a score or grading system that reflects the appeal of a real property or rental unit from the perspective of the prospective buyer or tenant and that is typically based upon the quality, condition, and congruence of the FFFEs of that property or rental unit. The AQS may consist of qualitative components alone, but more typically is a combination of qualitative and quantitative components that together have a combined impact on the perceived value of the property from the perspective of a buyer or lessee.

The AQS is constructed from the following elements: an array of items (features, finishes, fixtures and equipment, separate from the already intrinsically quantifiable characteristics, such as square feet, #bedrooms, #bathrooms, age, etc.) determined to be important to a typical user in evaluating a property or unit for lease; a weighting of each item that reflects the relative importance of each item to a typical user in the overall evaluation of the property or unit for lease; a set of criteria for each item that describes a desirable and/or an undesirable version of that item from the perspective of a typical user; a method for quantifying how closely the characteristics of that item match a desirable version of that item from the perspective of a typical user; and an algorithm for combining all of the above into a single numerical value that reflects the overall quality, from the typical user's perspective, of a single property or rental unit. This is then applied to each property or rental unit of a specific type of property.

For example, the Appeal Quality Scale, or AQS, for a multifamily apartment rental unit takes into consideration the aspects of the apartment unit itself that would most likely be evaluated by a prospective tenant in order for that tenant to determine how much the tenant would be willing to pay each month to rent that apartment unit, not including characteristics that are already intrinsically quantifiable in and of themselves, such as square footage, #bedrooms, #bathrooms, etc. Each of those aspects are then included as a component of the AQS score for that unit. In turn, each component of the AQS is assigned a weight based upon the estimated importance of that specific component to the overall assessment of appeal and value by the tenant. The ideal state for each component of the AQS is individually described to form the criteria against which the actual state of that component for an individual property or rental unit will be compared. Then, each component of the AQS is individually assessed, or rated, according to how well that particular apartment unit fulfills the desired criteria of a typical tenant for that particular component of the AQS. In some embodiments, this may be done by using a checklist that corresponds to the components used to calculate the AQS values of the other rental units in the model. Finally, the ratings for each component of the AQS are weighted and mathematically combined in an algorithm to calculate a single AQS score for that apartment unit. This score may be normalized over a scale of 0.00 to 1.00.

Continuing with the example above, each multifamily apartment unit that is within the selected geographic region (such as, but not limited to a MSA) and for which the relevant information is available, is then scored and assigned an AQS value, which is then stored in a database. Now that each rental unit is assigned an AQS value to encompass the qualitative aspects of the rental unit including condition, quality and appeal of the rental unit, other intrinsically quantifiable independent variable predictors of rental rates such as square footage, age, etc. are inputted into an AVM to predict rental rates. Now, when the AVM is predicting the rental rate of a single subject rental unit, by prompting and allowing the user of the AVM to specify the quantitative and qualitative aspects of the actual or projected FFFEs of the subject unit, the AQS of the subject rental unit is calculated based upon the algorithm referenced above, and the AVM will use the AQS to more accurately predict the current or projected rental rate of the subject rental unit. In some embodiments, the actual AQS is the quality value of the rental unit or property as is, while the projected AQS is the quality value of a rental unit or property that is yet to be built or is yet to be upgraded.

The incorporation of the AQS score allows the AVM to differentiate between a $500 per month unit that is 40 years old and 600 square feet in size from a $1,000 per month unit that is also 40 years old and 600 square feet in size and at the same location, but that has been completely updated with all new FFFEs that are most desirable to a typical tenant for that unit.

Continuing with the example above, the AQS for this multifamily apartment property type incorporates multiple components, including those of a subjective nature, that can be measured in a quantitative or binary way suitable for incorporating into an algorithm to produce a single AQS score for a given property or rental unit. This scoring can be structured where each FFFE represents a unique feature, finish, fixture or equipment of the property or rental unit. In some embodiments, a finish refers to aspects such as the type of paint, flooring, stucco, etc. In some embodiments, a fixture refers to a type of toilet, sink, cabinet, etc. In some embodiments, equipment refers to a type of refrigerator, stove, or other appliance, etc.

In some embodiments, only binary answers (yes or no) may be required to determine whether or not a rental unit or property meets the qualitative criteria of a user's ideal state for that particular component of the AQS for a rental unit or property. In other embodiments, the qualifying questions may be answered according to a graduated scale (a scale of 1 to 10 for example). In other embodiments, the answers to the qualifying questions may comprise a combination of binary answers, graduated scale answers, or any answer capable of expressing a qualitative aspect as a quantitative value.

While one embodiment of this invention includes the discrete step of calculating a separate AQS consisting at least in part of the weighting and rating of qualitative aspects of a rental unit or property, the weighting and rating of qualitative aspects of a rental unit or property may also be performed as a more integrated and continuous part of a statistical analysis, regression or machine learning process where binary or quantitative values are used to describe qualitative aspects that determine the overall condition, quality and congruence of a rental unit or property from the perspective of an end user.

The present invention translates qualitative judgments into quantitative measures, thereby enabling the automation of tasks that have traditionally required manual, subjective judgment. The present invention uses this quantitative measure of qualitative characteristics of FFEs, in combination with one or more permanent physical characteristics, economic characteristics and geographic characteristics of the area surrounding the property as a method to objectively and accurately estimate the resale or rental value of a rental unit or property.

Without incorporating an Appeal Quality Scale (AQS) for the properties provided as input into rent and value prediction models, as well as to the subject rental unit or property being analyzed and provided as output, further analysis used for prediction, such as the spatial analysis, is severely limited. By including this novel AQS into the base prediction model, it enables cleaner and more accurate input to be used within downstream spatial modeling analysis, resulting in more accurate and more precise output from other aspects of the described statistical and spatial models as well. Furthermore, by incorporating this previously ignored highly predictive component, it now becomes possible to more accurately isolate, model, analyze and predict the location component contribution to rental rates and property values and also to better predict the potential value of raw land suitable for development into improved properties for lease or rent.

With regards to prior arts, binary data fields of a checklist indicating the mere presence or absence of a general type of fixture, finish or equipment are also often insufficient due to the potential differences in age, quality, and condition of otherwise nominally equal fixtures, finishes, and equipment. For example, a simple checkbox indicating whether or not a rental unit or property has vinyl flooring does not indicate whether the vinyl flooring is 50 years old, with substantial wear and tear, and of an outdated style or vinyl flooring that is newly installed, in good condition, and of a modern design. Yet, this difference alone is exactly the type of difference that will have a significant impact on the rental or resale value of the property. The two different versions of vinyl flooring in the example above will have respectively lesser and greater appeal and value to potential buyers or lessors. In other words, a buyer and lessee are both likely to pay more, and the seller or lessor to charge more, for the second scenario than the first. This and comparable qualitative differences impact value, even when the nominal value is the same.

Examples of other FFFEs to which these qualitative aspects, including quality, condition, and congruence, among others, may apply and be incorporated into the AQS include cabinets, countertops, cabinet pulls, hardware (door handles, hinges, etc.), lighting fixtures, floor plan/layout, the configuration of kitchen appliances and cabinets, lighting (natural and artificial), light fixtures and fans, electrical outlets, and switches, flooring of all types, appliances of all finishes and types, paint schemes (interior and exterior), plumbing fixtures and finishes (showers, baths, toilets, sinks, and faucets), bathroom hardware (towel racks, robe hooks and toilet paper dispensers), mirrors, windows, doors, drywall finishes, exterior cladding, roofing, tenant improvements of all types for commercial properties, clubhouses, pools, gyms and fitness areas, media rooms, yards and patios, storage areas, parking areas, etc.

This method incorporates machine learning models while preserving transparency, explainability and traceability to major value contributing components. It uses a multi-modal imaging processing pipeline to systematically grade and turn qualitative property condition characteristics into quantitative scores. These graduated condition scores enable the model to generate more accurate price estimates and also help the user to more efficiently perform as-if evaluations, generate full after repair values, and quickly find the properties (“comparables”) most economically similar to the subject property. The method creates homogenous groups and sub-groups of economically similar properties to supplement sparse data situations and find shared patterns between prices and value contributing characteristics within and across these groups. This method allows its users to evaluate real estate efficiently and accurately, and in a way that can be easily understood and explained to others in human language terms typically associated with real estate, while still performing automated learning and data processing that far exceeds the capacity of the human mind. The method described here includes the option for the user to view the data as it goes through intermediate steps via data visualization tools and tables, and allows the user to input proposed improvements to the property, select individual transactions for inclusion or exclusion as the basis for evaluation and instantly see the impact of corrected input values or contemplated improvements on the property's value. Investors and other real estate professionals working with investors in particular need an efficient method to calculate the as-is and after repair value of a property, as a flip or as a buy and hold rental income property, in order to determine the suitability of purchasing and financing the property for investment. The proposed method addresses the described missing components of the real property evaluation process in a way that does not currently exist.

The present invention is directed to a specific, computer-implemented method for transforming raw comparable property transactions into normalized predictor variables through a defined, multi-stage computational process. This is a technical solution that improves the functionality of computer-based valuation systems. In some embodiments, the processor of the present invention may perform: (1) regression between transaction price (or rent) and size to generate size-normalization curves; (2) calculation of Appeal Quality Scale (AQS) scores from weighted feature values; (3) pairwise residual analysis to derive a General AQS Value (GAV) representing the full range of feature contribution; (4) residual-based location modeling using spatial algorithms such as kriging or inverse-distance weighting; (5) differential adjustment of all predictor components for each comparable; and (6) algorithmic averaging of adjusted comparable values to produce a predicted rental rate or property value. These are discrete computational steps that create new intermediate machine-generated variables.

The algorithms are practically applied to real comparable data and used to generate actionable valuation outputs for specific properties. The system constructs intermediate predictors (size-adjusted values, AQS, GAV, spatial residual surfaces) and uses these technical transformations to produce a concrete, real-world output: a predicted rental rate or property value. The processor is not used as a passive calculation tool but as an active computational engine executing a structured sequence of interdependent algorithms for (i) normalizing heterogeneous transaction data through regression; (ii) deriving feature-based predictors through weighted scoring and residual decomposition; (iii) computing location effects from structured residual records using geostatistical modeling; or (iv) dynamically recomputing valuation outputs as comparables are added or removed, thus improving data processing and generating machine-created intermediate representations.

One of the unique and inventive technical features of the present invention is the establishment of an AQS scoring system for converting individual and combined qualitative aspects into individual and combined incremental quantitative values. Without wishing to limit the invention to any theory or mechanism, it is believed that the technical feature of the present invention advantageously provides for accurate, efficient, and consistent valuation of properties that overcomes the issues of prior systems for property value estimation by providing quantitative values for qualitative comparison points for any rental unit or property. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIGS. 1A-1B show a flow chart of a method for objectively and accurately estimating property values and rental rates, as implemented in the present invention, comprising determining an AQS value based on surveys, online user reviews, ratings, and rankings for individual features, finishes and equipment, gathered from property owners/renters and statistically determining the effect that the AQS value and its individual components will have on the final value of the unit or property based on statistical analysis.

FIGS. 2A-2B shows a flow chart of an alternate embodiment of a method for objectively and accurately estimating a property's value and rental rates, comprising the use of surveys and survey results to assist in an initial determination of which AQS components should be included in calculating the AQS for that property type and how those individual components are best weighted and scored and combined into a single algorithm for determining an AQS value based on survey results gathered from property owners/renters and statistically determining the effect that the AQS value and its individual components will have on the final value of the property based on statistical analysis.

FIGS. 3A-3B show a flow chart of another alternate embodiment of a method for objectively and accurately estimating a property value, by first segmenting (classifying) rental property units into tiers of AQS values and then comparing properties and rental units of like AQS values to more accurately model and ascertain other predictive independent variables, including location values, to more accurately predict property values and rental rates.

FIG. 4 provides a rudimentary example of how the AQS for a multifamily rental unit or property can be used to improve the prediction accuracy of a simple regression model. In the first model, line 1, rents are predicted using unit square footage alone as the sole independent variable. In the second model, line 2, the AQS (previously referred to as “TRF” for Total Renovation Factor) is included as a second independent variable. Accuracy, as measured by R squared, improves substantially from 0.602 to 0.793. While these R squared values are not particularly noteworthy in and of themselves, based upon only one or two independent variables, the incremental improvement in the accuracy is substantial and indicative of the potential gains in accuracy that are possible by incorporating the AQS value into more comprehensive predictive models.

FIG. 5 shows a flow chart of a system of the present invention for calculating and displaying explainable predictions of rental rate, operational cost, value-addition, loan data, and profit potential for one or more properties.

FIG. 6 shows a flow chart of an application allowing a user to calculate and display explainable predictions of rental rate, operational cost, value-addition, loan data, and profit potential for one or more properties.

FIG. 7 shows an example diagram of the application for allowing a user to view and analyze physical qualitative features of comparable properties along with location, square footage, age, and unit type to accurately predict rental rates.

FIG. 8 shows an example diagram of the application for allowing a user to view and analyze value-additions and construction costs as a result of improvements to the property.

FIG. 9A shows a graph of equity over time.

FIG. 9B shows a graph of cash flow growth over time.

FIG. 10 shows a flowchart diagram of an image processing model pipeline for explainable, modifiable, component-based property condition score.

FIGS. 11A-11B show a flowchart diagram of the acquisition guidance system of the present invention.

### DETAILED DESCRIPTION OF THE INVENTION

The term “value” as used herein may refer to property value or unit or property rental rate value.

The term “similar” is defined herein as having a value within a certain threshold when used in reference to size and age (e.g. within 50 square feet, within 5 years). When used in reference to physical features, the term “similar” refers to sharing a certain number of physical features with another rental unit or property (e.g. sharing 3 or more physical features). When used in reference to operational characteristics, the term “similar” refers to qualitative similarities between one rental unit or property and another, such as one or more properties under management by the same owner or property management company. When used in reference to online reputation, the term “similar” refers to quantitative and qualitative similarities between online reviews, ratings and presence among internet rental or sales listing sites or advertising sites between one rental unit or property and another.

The term “different” is defined herein as having a value outside a certain threshold when used in reference to size and age (e.g. more than 50 square feet of difference, more than 5 years of difference). When used in reference to physical features, the term “different” refers to lacking a certain number of physical features possessed by another rental unit or property (e.g. sharing less than 3 physical features). When used in reference to operational characteristics, the term “different” refers to qualitative differences between one rental unit or property and another, such as properties under management by different owners or property management companies. When used in reference to online reputation, the term “different” refers to quantitative and qualitative differences between online reviews, ratings and presence among internet rental or sales listing sites or advertising sites between one rental unit or property and another.

The term “completely updated” is defined herein as containing all possible physical features and improvements, each with a maximum possible quality.

The term “corresponding rental rate value component” is defined herein as a rental rate value component of a comparable property directed to the same attribute (e.g. size, physical features, age, location, operational characteristics, online reputation characteristics) as a rental rate value component of the subject property, or vice versa.

The term “differential value” is defined herein as a value representing and/or dependent on a difference between two other values.

The term “completely outdated” is defined herein as lacking all possible physical features and improvements that are typically associated with a rental unit or property that has been newly constructed or completely updated within the past five to ten years.

The term “valuation subject” is defined herein as any property or portion of a property (e.g., a rentable unit in a property, such as a rentable room, apartment unit, condo, etc.), or a transaction or transaction record thereof, with a financial value attached to it.

The term “comparable” is defined herein as one or more property sales, rentals of properties or portions of properties, or transactions or transaction records thereof, with the absolute differences from a subject property below a given threshold, presented to the user as most economically similar to the subject property.

The term “financial value” is defined herein as the cost of a given property in the form of rental rate or property value/sale price, associated with a past, present, or future transaction.

The present invention features a method, in a computer system having a processor, for calculating and displaying an explainable financial value prediction of one or more valuation subjects by isolating a plurality of financial value components of the valuation subject, the plurality of financial value components comprising location, size, and one or more physical features. The method may comprise identifying, from a database comprising data associated with a plurality of properties, a plurality of comparables, each comparable comprising a known financial value for each comparable, and a plurality of comparable financial value components, the plurality of comparable financial value components comprising location, size, and one or more physical features. The plurality of comparables may comprise a first subset of comparables comprising two or more comparables having different sizes, and similar physical features and location, a second subset of comparables comprising two or more comparables having different physical features, and similar size and location.

The method may further comprise calculating, by the processor, for each comparable of the time-adjusted second subset of comparables, an appeal quality scale (AQS) value. The method may further comprise adjusting, by the processor, for each comparable, the known financial values for time by generating a monthly market-value index from comparable known financial values within a given non-outlier range, and applying the monthly market-value index to the known financial values, resulting in time-adjusted financial values. The method may further comprise quantifying, by the processor, an effect of size on financial value based on the time-adjusted first subset of comparables. The method may further comprise determining, by the processor, for each comparable of the time-adjusted second subset of comparables, for each physical feature, a value and a weight, wherein the value is determined based on a quality of the feature, wherein the weight is determined based on an estimated percentage of which the feature contributes to an overall appeal of the comparable.

The method may further comprise quantifying, by the processor, an effect of physical features on financial value based on the AQS values of the second subset of comparables. The method may further comprise grouping, by computer-generated clustering logic implemented on the processor, the plurality of comparables into location groups such that each location group is determined by an existing geographical subdivision, census-based geographic units, clusters exhibiting low variance in time-adjusted financial values, or a combination thereof. The method may further comprise deriving, by the processor, for each location group, based on a regression of the effect of size on financial value and the effect of physical features on financial value, an effect of location on financial value, resulting in a fitted curve. The method may further comprise computing, by the processor, for each location group, residual values by dividing the time-adjusted financial values by predicted prices derived from the fitted curve. The method may further comprise determining, by the processor, based on the residual values, upper and lower percentile-based residual bands. The method may further comprise calculating, by the processor, based on a size of the one or more valuation subjects, one or more physical features of the one or more valuation subjects, a location of the one or more valuation subjects, the fitted curve, and the upper and lower percentile-base residual bands, a predicted financial value of at least one of the one or more valuation subjects of the valuation subject.

In some embodiments, the plurality of comparable financial value components may further comprise one or more additional characteristics. The plurality of comparables may further comprise a fourth subset of comparables comprising two or more comparables having different additional characteristics, and similar size, physical features, and location. The method may further comprise quantifying, by the processor, an effect of additional characteristics on financial value based on the fourth subset of comparables. Calculating the predicted financial value may be further based on the effect of additional characteristics on financial value and one or more additional characteristics of the one or more valuation subjects. Quantifying the effect of additional characteristics on financial value may comprise, for each additional characteristic of the one or more additional characteristics, measuring and averaging differences in financial values relative to differences in the additional characteristic within one or more groupings of comparables within the fourth subset of comparables. The one or more additional characteristics may comprise age, form and quality of property management, maintenance, customer service, offered resident services, communication quality and channels between residents and property management, advertising, marketing, sales practices, pricing strategy, promotions, retention programs, concessions, resident rewards programs, quantitative and qualitative measures of online reviews, ratings and presence among internet rental or sales listing sites or advertising sites, or a combination thereof.

In some embodiments, quantifying the effect of size on financial value may comprise calculating, by the processor, for each comparable of the first subset of comparables, a financial value per square foot value based on the size and the known financial value of each comparable of the plurality of comparables. The method may further comprise calculating, by the processor, a best-fit equation for two or more comparables of the first subset of comparables relating the financial value per square foot value to the size. The method may further comprise calculating, by the processor, an average best-fit equation approximating a weighted average of the best-fit equations for the comparables of the first subset of comparables. A weight of each best-fit equation of each comparable may be based on a number of comparables from which each best-fit equation is derived. The effect of size on financial value may be calculated by inputting the size of each valuation subject of the at least one of the one or more valuation subjects into the average best-fit equation.

Determining, for each comparable of the second subset of comparables, for each physical feature, the value may comprise analyzing one or more images of the physical feature by human analysis, computer vision, or a combination thereof. Quantifying an effect of physical features on financial value may comprise selecting, by the processor, a pair of comparables r1 and r2 within a comparable of the second subset, such that an AQS value of r1, AQS1, is less than an AQS value for r2, AQS2, calculating, by the processor, intermediate predicted financial values for r1 and r2 based on the effect of size on financial value, subtracting, by the processor, the intermediate predicted financial value for r1 from the known financial value of r1, resulting in a difference d1, subtracting, by the processor, the intermediate predicted financial value for r2 from the known financial value of r2, resulting in a difference d2, calculating, by the processor, a rate of change in financial value with respect to a change in AQS value, by subtracting d1 from d2, resulting in a difference d3, and dividing d3 by a difference resulting from subtracting AQS1 from AQS2, resulting in a value of financial value per AQS value, repeating the prior steps for each pair of comparables of each comparable of the second subset, and averaging, by the processor executing pairwise residual analysis, the values of financial value per AQS value for each pair of comparables of each comparable of the second subset, resulting in a General AQS Value (GAV). The GAV may represent an estimated additional value contributed to comparable financial value if a comparable was completely updated as compared to if the comparable was completely outdated. Quantifying an effect of physical features on financial value may further comprise averaging, by the processor, the AQS values of the comparables of the second subset of comparables, resulting in an average AQS value and calculating, by the processor, based on the GAV, the average AQS value, and the AQS value of the at least one of the one or more valuation subjects of the valuation subject, the effect of physical features on financial value.

In some embodiments, deriving the effect of location on financial value may comprise predicting, by the processor, intermediate financial value for each comparable based on the effect of size on financial value, and the effect of physical features on financial value, measuring, by the processor, for each comparable, a residual error by calculating a difference of the intermediate financial value from the known financial value, storing, by the processor, for each comparable, the residual error and location coordinates of the comparable in a structured data format, incorporating, by the processor, for each comparable, one or more additional predictor variables to the structured data format, the one or more additional predictor variables comprising economic data of an area surrounding the location, demographic data of the area surrounding the location, crime rates of the area surrounding the location, familial status data of the area surrounding the location, distance from the location to one or more key locations of interest, or a combination thereof, and applying, by the processor, one or more spatial modeling and geostatistical algorithms to the structured data format to determine the effect of location on financial value, the one or more spatial modeling and geostatistical algorithms comprising kriging, inverse-distance weighting, or a combination thereof.

In some embodiments, calculating the predicted financial value of the at least one of the one or more valuation subjects of the valuation subject may comprise applying, for each comparable relative to the valuation subject, for each comparable financial value component of the plurality of comparable financial value components, a differential value based on the comparable financial value component compared to a corresponding financial value component of the valuation subject, summing, for each comparable, the differential values of the plurality of comparable financial value components resulting in a sum of differential values, adding, for each comparable, the sum of differential values to the known financial value of the comparable, resulting in an intermediate predicted financial value for the valuation subject based upon the comparable, and calculating an average of the plurality of intermediate predicted financial values resulting in the predicted financial value of the at least one of the one or more valuation subjects of the valuation subject.

The method may further comprise adding the predicted financial value to the database, comparing the predicted financial value to the known financial values of the plurality of comparables and an effect of each financial value component on financial values, and iteratively adjusting the effect of each financial value component on financial values such that a difference between the predicted financial value and the known financial values is minimized. The predicted financial value of the at least one of the one or more valuation subjects of the valuation subject may be further based on a manual adjustment from a user. The manual adjustment may comprise an addition of value or a subtraction of value applied to an intermediate predicted financial value of the plurality of intermediate predicted financial values, the predicted financial value, or a combination thereof, selection or deselection of one or more intermediate predicted financial values of the plurality of intermediate predicted financial values from calculating the average, filtering the plurality of comparables by the plurality of comparable financial value components, or a combination thereof.

The method may further comprise displaying, by the processor, the plurality of comparables on a display component such that the plurality of comparables are sorted into a list such that comparables most similar to the valuation subject are earlier in the list by a sorting method. The sorting method may comprise calculating, for each comparable financial value component of a comparable, a differential value based on the comparable financial value component compared to a corresponding financial value component of the valuation subject and an effect of the corresponding financial value component on financial value, summing an absolute value of each differential value into a sum of absolute differences, repeating the previous steps for each comparable of the plurality of comparables, and sorting the plurality of comparables by the sum of absolute differences of each comparable. The list may comprise the plurality of comparables.

The method may further comprise displaying, by the processor, the plurality of comparables on a display component such that the plurality of comparables are filtered, sorted, or a combination thereof by a number of physical features. The method may further comprise calculating, by the processor, a predicted net operating income of the valuation subject. Calculating the predicted net operating income may comprise calculating, by the processor, for each valuation subject of the valuation subject, the predicted financial value, adding, by the processor, the predicted financial value of each valuation subject, resulting in a gross rents value, subtracting, by the processor, a percentage of the gross rents value representing estimated loss to lease, vacancy, concessions, delinquency, or a combination thereof, adding a percentage of the gross rents value representing additional sources of revenue including estimated utility reimbursements, equipment rentals, pet rents and deposits, parking revenue, application fees, collections, late charges, lease break fees, or a combination thereof to the gross rents value, resulting in an effective gross income value, estimating, by the processor, based on the location of the valuation subject, a tax expense for the valuation subject, estimating, by the processor, based on insurance data of the plurality of comparables, an insurance expense for the valuation subject, estimating, by the processor, a payroll expense for the valuation subject, estimating, by the processor, a utility expense for the valuation subject, estimating, by the processor, a repair and maintenance expense for the valuation subject, estimating, by the processor, a property management fee expense for the valuation subject, estimating, by the processor, an advertising, marketing and administrative expense for the valuation subject, and calculating, by the processor, based on the effective gross income, the tax expense, the insurance expense, the payroll expense, the utility expense, the repair and maintenance expense, the property management fee expense, and the advertising, marketing and administrative expense, the predicted net operating income of the valuation subject.

The method may further comprise calculating, by the processor, a revised predicted net operating income and a predicted project cost associated with one or more hypothetical value-adding improvements to the at least one valuation subject. Calculating the revised predicted net operating income and a predicted project cost may comprise calculating, by the processor, based on the effect of physical features on financial value and known operating expense values, a revised estimated net operating income for the valuation subject as a result of an addition of the one or more hypothetical value-adding improvements not present in the at least one valuation subject of the one or more valuation subjects, calculating, by the processor, for each hypothetical value-adding improvements of the one or more hypothetical value-adding improvements, a construction cost comprising a cost of materials, a cost of labor, a cost of design, a cost of permitting, a cost of utilities, a cost of insurance, and a cost of non-revenue producing time of the at least one valuation subject during construction, and calculating, by the processor, based on an added value of the one or more hypothetical value-adding improvements and the construction cost of each hypothetical value-adding improvements of the one or more new physical features, the revised predicted net operating income and the predicted project cost.

The method may further comprise calculating, by the processor, a predicted loan rate of the valuation subject. Calculating the predicted loan rate may comprise estimating, by the processor, based on a set of current market data from a market data database, a size of a loan likely to be approved for the valuation subject, estimating, by the processor, based on the set of current market data, an interest rate of the loan, estimating, by the processor, based on the set of current market data, a term and amortization schedule for the loan, estimating, by the processor, based on the set of current market data, a frequency of payments of the loan, estimating, by the processor, based on the set of current market data, fees of the loan, and calculating, by the processor, based on the size of the loan, the interest rate, the term and amortization schedule, the frequency of payments, and the loan fees, the predicted loan rate of the valuation subject.

The method may further comprise calculating, by the processor, with and without the one or more hypothetical value-adding improvements, one or more predicted property valuation metrics including a predicted pro forma revenue, one or more expense line items, gross rents, effective gross income, operating expenses, operating expense ratio, net operating income, gross rent multiplier, capitalization rate, estimated resale value, loan to value ratio, debt service coverage ratio, yield on cost, debt service, cashflow, total project cost, profit potential, maximum recommended offer amount, price per square foot, return on investment, cash-on-cash return, internal rate of return or a combination thereof. The method may further comprise filtering, sorting, stratifying or classifying, by the processor, the valuation subject, one or more comparables of the plurality of comparables, or a combination thereof, according to one or more predicted property valuation metrics, and displaying representations of the valuation subject, the one or more comparables of the plurality of comparables, or the combination thereof with markers or labels of different colors, shapes, sizes, or a combination thereof corresponding to different ranks, tiers or classes of properties in a mapped, graphical, or tabular form.

The method may further comprise tracking and calculating valuation metrics of the valuation subject, the one or more comparables of the plurality of comparables, or the combination thereof upon detecting the valuation subject, the one or more comparables of the plurality of comparables, or the combination thereof listed on internet listing sites, and providing alerts when at least one of one or more predicted property valuation metrics of the valuation subject, the one or more comparables of the plurality of comparables, or the combination thereof matches user preferences related to at least one valuation metric of the plurality of valuation metrics. The method may further comprise calculating, by the processor, predicted debt, equity and cashflow growth values over time for the valuation subject, the one or more comparables of the plurality of comparables, or the combination thereof, and displaying the predicted debt, equity and cashflow growth values over time in a graphical format, the graphical format comprising a line or stacked area chart, on a display component.

The present invention implements a broader condition-scoring process involving image-derived component scores that are consolidated and weighted, with weights informed initially by expert judgment and refined through regression. The final valuation step may use the subject unit's condition/AQS to position the subject between the upper and lower percentile-based residual bands at the subject's size, which operates as an interpolation mechanism.

The present invention features a method, in a computer system having a processor, for calculating and displaying an explainable financial value prediction of one or more subject units of a subject property by isolating a plurality of financial value components of the subject property, the plurality of financial value components comprising location, size, and one or more physical features. The method may comprise identifying, from a database comprising data associated with a plurality of properties, a plurality of comparable properties, each comparable property comprising a plurality of comparable units, a known financial value for each unit of the plurality of comparable units, and a plurality of comparable financial value components, the plurality of comparable financial value components comprising location, size, and one or more physical features. The plurality of comparable properties may comprise a first subset of comparable properties, each comparable property of the first subset comprising two or more units having different sizes, and similar physical features and location. The plurality of comparable properties may further comprise a second subset of comparable properties, each comparable property of the second subset comprising two or more units having different physical features, and similar size and location; quantifying, by the processor, an effect of size on financial value based on the first subset of comparable properties.

The method may further comprise determining, by the processor, for each comparable property of the second subset of comparable properties, for each comparable unit, for each physical feature, a value and a weight, wherein the value is determined based on a quality of the feature. The weight may be determined based on an estimated percentage of which the feature contributes to an overall appeal of the comparable unit. The method may further comprise calculating, by the processor, for each comparable unit of each comparable property of the second subset of comparable properties, an appeal quality scale (AQS) value comprising a sum of a product of the value and the weight of each physical feature of the comparable unit. The method may further comprise quantifying, by the processor, an effect of physical features on financial value based on the AQS values of the second subset of comparable properties. The method may further comprise adjusting, by the processor, for each comparable property, the known financial values for time by generating a monthly market-value index from comparable property known financial values within a given non-outlier range, and applying the monthly market-value index to the known financial values, resulting in time-adjusted financial values.

The method may further comprise grouping, by the processor, the plurality of comparable properties into location groups such that each location group is determined by an existing geographical subdivision, census-based geographic units, clusters exhibiting low variance in time-adjusted financial values, or a combination thereof. The method may further comprise deriving, by the processor, for each location group, based on a regression of the effect of size on financial value and the effect of physical features on financial value, an effect of location on financial value, resulting in a fitted curve. The method may further comprise computing, by the processor, for each location group, residual values by dividing the time-adjusted financial values by predicted prices derived from the fitted curve. The method may further comprise determining, by the processor, based on the residual values, upper and lower percentile-based residual bands. The method may further comprise calculating, by the processor, based on a size of the one or more subject units, one or more physical features of the one or more subject units, a location of the one or more subject units, the fitted curve, and the upper and lower percentile-base residual bands, a predicted financial value of at least one of the one or more subject units of the subject property.

In some embodiments, the plurality of comparable financial value components may further comprise one or more additional characteristics. In some embodiments, the plurality of comparable properties may further comprise a fourth subset of comparable properties, each comparable property of the fourth subset comprising two or more units having different additional characteristics, and similar size, physical features, and location. The method may further comprise quantifying, by the processor, an effect of additional characteristics on financial value based on the fourth subset of comparable properties. Calculating the predicted financial value may be further based on the effect of additional characteristics on financial value and one or more additional characteristics of the one or more subject units. Quantifying the effect of additional characteristics on financial value may comprise, for each additional characteristic of the one or more additional characteristics, measuring and averaging differences in financial values relative to differences in the additional characteristic within one or more groupings of comparable units within the fourth subset of comparable properties. The one or more additional characteristics may comprise age, form and quality of property management, maintenance, customer service, offered resident services, communication quality and channels between residents and property management, advertising, marketing, sales practices, pricing strategy, promotions, retention programs, concessions, resident rewards programs, quantitative and qualitative measures of online reviews, ratings and presence among internet rental or sales listing sites or advertising sites, or a combination thereof.

In some embodiments, quantifying the effect of size on financial value may comprise calculating, by the processor, for each comparable property of the first subset of comparable properties, a financial value per square foot value based on the size and the known financial value of each unit of the plurality of comparable units. Quantifying the effect of size on financial value may further comprise calculating, by the processor, a best-fit equation for two or more comparable units of each comparable property of the first subset of comparable properties relating the financial value per square foot value to the size. Quantifying the effect of size on financial value may further comprise calculating, by the processor, an average best-fit equation approximating a weighted average of the best-fit equations for the comparable units of each property of the first subset of comparable properties, wherein a weight of each best-fit equation of each property is based on a number of units from which each best-fit equation is derived. The effect of size on financial value may be calculated by inputting the size of each subject unit of the at least one of the one or more subject units into the average best-fit equation.

In some embodiments, determining, for each comparable property of the second subset of comparable properties, for each comparable unit, for each physical feature, the value may comprise analyzing one or more images of the physical feature by human analysis, computer vision, or a combination thereof. In some embodiments, quantifying an effect of physical features on financial value may comprise selecting, by the processor, a pair of comparable units r1 and r2 within a comparable property of the second subset, such that an AQS value of r1, AQS1, is less than an AQS value for r2, AQS2. Quantifying an effect of physical features on financial value may further comprise calculating, by the processor, intermediate predicted financial values for r1 and r2 based on the effect of size on financial value. Quantifying an effect of physical features on financial value may further comprise subtracting, by the processor, the intermediate predicted financial value for r1 from the known financial value of r1, resulting in a difference d1. Quantifying an effect of physical features on financial value may further comprise subtracting, by the processor, the intermediate predicted financial value for r2 from the known financial value of r2, resulting in a difference d2. Quantifying an effect of physical features on financial value may further comprise calculating, by the processor, a rate of change in financial value with respect to a change in AQS value, by subtracting d1 from d2, resulting in a difference d3, and dividing d3 by a difference resulting from subtracting AQS1 from AQS2, resulting in a value of financial value per AQS value. Quantifying an effect of physical features on financial value may further comprise repeating these steps for each pair of comparable units of each comparable property of the second subset.

Quantifying an effect of physical features on financial value may further comprise averaging, by the processor executing pairwise residual analysis, the values of financial value per AQS value for each pair of comparable units of each comparable property of the second subset, resulting in a General AQS Value (GAV), wherein the GAV represents an estimated additional value contributed to unit financial value if a unit was completely updated as compared to if the unit was completely outdated. Quantifying an effect of physical features on financial value may further comprise averaging, by the processor, the AQS values of the comparable units of the second subset of comparable properties, resulting in an average AQS value. Quantifying an effect of physical features on financial value may further comprise calculating, by the processor, based on the GAV, the average AQS value, and the AQS value of the at least one of the one or more subject units of the subject property, the effect of physical features on financial value.

In some embodiments, deriving the effect of location on financial value may comprise predicting, by the processor, intermediate financial value for each comparable unit of each comparable property based on the effect of size on financial value, and the effect of physical features on financial value. Deriving the effect of location on financial value may further comprise measuring, by the processor, for each comparable unit of each comparable property, a residual error by calculating a difference of the intermediate financial value from the known financial value. Deriving the effect of location on financial value may further comprise storing, by the processor, for each comparable unit of each comparable property, the residual error and location coordinates of the comparable unit in a structured data format. Deriving the effect of location on financial value may further comprise incorporating, by the processor, for each comparable unit of each comparable property, one or more additional predictor variables to the structured data format, the one or more additional predictor variables comprising economic data of an area surrounding the location, demographic data of the area surrounding the location, crime rates of the area surrounding the location, familial status data of the area surrounding the location, distance from the location to one or more key locations of interest, or a combination thereof. Deriving the effect of location on financial value may further comprise applying, by the processor, one or more spatial modeling and geostatistical algorithms to the structured data format to determine the effect of location on financial value, the one or more spatial modeling and geostatistical algorithms comprising kriging, inverse-distance weighting, or a combination thereof.

In some embodiments, calculating the predicted financial value of the at least one of the one or more subject units of the subject property may comprise applying, for each comparable unit of each comparable property of the plurality of comparable properties relative to the subject unit, for each comparable financial value component of the plurality of comparable financial value components, a differential value based on the comparable financial value component compared to a corresponding financial value component of the subject unit. Calculating the predicted financial value of the at least one of the one or more subject units of the subject property may further comprise summing, for each comparable unit of each comparable property of the plurality of comparable properties, the differential values of the plurality of comparable financial value components resulting in a sum of differential values. Calculating the predicted financial value of the at least one of the one or more subject units of the subject property may further comprise adding, for each comparable unit of each comparable property of the plurality of comparable properties, the sum of differential values to the known financial value of the comparable unit, resulting in an intermediate predicted financial value for the subject unit based upon the comparable unit. Calculating the predicted financial value of the at least one of the one or more subject units of the subject property may further comprise calculating an average of the plurality of intermediate predicted financial values resulting in the predicted financial value of the at least one of the one or more subject units of the subject property.

In some embodiments, the method may further comprise adding the predicted financial value to the database, comparing the predicted financial value to the known financial values of the plurality of comparable properties and an effect of each financial value component on financial values, and iteratively adjusting the effect of each financial value component on financial values such that a difference between the predicted financial value and the known financial values is minimized.

In some embodiments, the predicted financial value of the at least one of the one or more subject units of the subject property may be further based on a manual adjustment from a user. The manual adjustment may comprise an addition of value or a subtraction of value applied to an intermediate predicted financial value of the plurality of intermediate predicted financial values, the predicted financial value, or a combination thereof. The predicted financial value of the at least one of the one or more subject units of the subject property may be further based on selection or deselection of one or more intermediate predicted financial values of the plurality of intermediate predicted financial values from calculating the average. The predicted financial value of the at least one of the one or more subject units of the subject property may be further based on filtering the plurality of comparable properties by the plurality of comparable financial value components, or a combination thereof.

The method may further comprise displaying, by the processor, the plurality of comparable units of the plurality of comparable properties on a display component such that the plurality of comparable units are sorted into a list such that comparable units most similar to the subject unit are earlier in the list by a sorting method. The sorting method may comprise calculating, for each comparable financial value component of a comparable unit of the plurality of comparable units, a differential value based on the comparable financial value component compared to a corresponding financial value component of the subject unit and an effect of the corresponding financial value component on financial value. The sorting method may further comprise summing an absolute value of each differential value into a sum of absolute differences. The sorting method may further comprise repeating these steps for each comparable unit of the plurality of comparable units of the plurality of comparable properties. The sorting method may further comprise sorting the plurality of comparable units of the plurality of comparable properties by the sum of absolute differences of each comparable unit, wherein the list comprises the plurality of comparable units.

The method may further comprise displaying, by the processor, the plurality of comparable units of the plurality of comparable properties on a display component such that the plurality of comparable units are filtered, sorted, or a combination thereof by a number of physical features. The method may further comprise calculating, by the processor, a predicted net operating income of the subject property. Calculating the predicted net operating income may comprise calculating, by the processor, for each subject unit of the subject property, the predicted financial value. Calculating the predicted net operating income may further comprise adding, by the processor, the predicted financial value of each subject unit of the subject property or of the subject property as a whole, resulting in a gross rents value. Calculating the predicted net operating income may further comprise subtracting, by the processor, a percentage of the gross rents value representing estimated loss to lease, vacancy, concessions, delinquency, or a combination thereof. Calculating the predicted net operating income may further comprise adding a percentage of the gross rents value representing additional sources of revenue including estimated utility reimbursements, equipment rentals, pet rents and deposits, parking revenue, application fees, collections, late charges, lease break fees, or a combination thereof to the gross rents value, resulting in an effective gross income value.

Calculating the predicted net operating income may further comprise estimating, by the processor, based on the location of the subject property, a tax expense for the subject property. Calculating the predicted net operating income may further comprise estimating, by the processor, based on insurance data of the plurality of comparable properties, an insurance expense for the subject property. Calculating the predicted net operating income may further comprise estimating, by the processor, a payroll expense for the subject property. Calculating the predicted net operating income may further comprise estimating, by the processor, a utility expense for the subject property. Calculating the predicted net operating income may further comprise estimating, by the processor, a repair and maintenance expense for the subject property. Calculating the predicted net operating income may further comprise estimating, by the processor, a property management fee expense for the subject property. Calculating the predicted net operating income may further comprise estimating, by the processor, an advertising, marketing and administrative expense for the subject property. Calculating the predicted net operating income may further comprise calculating, by the processor, based on the effective gross income, the tax expense, the insurance expense, the payroll expense, the utility expense, the repair and maintenance expense, the property management fee expense, and the advertising, marketing and administrative expense, the predicted net operating income of the subject property.

The method may further comprise calculating, by the processor, a revised predicted net operating income and a predicted project cost associated with one or more hypothetical value-adding improvements to the at least one subject unit of the one or more subject units of the subject property. Calculating the revised predicted net operating income and a predicted project cost may comprise calculating, by the processor, based on the effect of physical features on financial value and known operating expense values, a revised estimated net operating income for the subject property as a result of an addition of the one or more hypothetical value-adding improvements not present in the at least one subject unit of the one or more subject units of the subject property. Calculating the revised predicted net operating income and a predicted project cost may further comprise calculating, by the processor, for each hypothetical value-adding improvements of the one or more hypothetical value-adding improvements, a construction cost comprising a cost of materials, a cost of labor, a cost of design, a cost of permitting, a cost of utilities, a cost of insurance, and a cost of non-revenue producing time of the at least one subject unit during construction. Calculating the revised predicted net operating income and a predicted project cost may further comprise calculating, by the processor, based on an added value of the one or more hypothetical value-adding improvements and the construction cost of each hypothetical value-adding improvements of the one or more new physical features, the revised predicted net operating income and the predicted project cost.

The method may further comprise calculating, by the processor, a predicted loan rate of the subject property. Calculating the predicted loan rate may comprise estimating, by the processor, based on a set of current market data from a market data database, a size of a loan likely to be approved for the subject property. Calculating the predicted loan rate may further comprise estimating, by the processor, based on the set of current market data, an interest rate of the loan. Calculating the predicted loan rate may further comprise estimating, by the processor, based on the set of current market data, a term and amortization schedule for the loan. Calculating the predicted loan rate may further comprise estimating, by the processor, based on the set of current market data, a frequency of payments of the loan. Calculating the predicted loan rate may further comprise estimating, by the processor, based on the set of current market data, fees of the loan. Calculating the predicted loan rate may further comprise calculating, by the processor, based on the size of the loan, the interest rate, the term and amortization schedule, the frequency of payments, and the loan fees, the predicted loan rate of the subject property.

The method may further comprise calculating, by the processor, with and without the one or more hypothetical value-adding improvements, one or more predicted property valuation metrics including a predicted pro forma revenue, one or more expense line items, gross rents, effective gross income, operating expenses, operating expense ratio, net operating income, gross rent multiplier, capitalization rate, estimated resale value, loan to value ratio, debt service coverage ratio, yield on cost, debt service, cashflow, total project cost, profit potential, maximum recommended offer amount, price per square foot, return on investment, cash-on-cash return, internal rate of return or a combination thereof. The method may further comprise filtering, sorting, stratifying or classifying, by the processor, the subject property, one or more comparable properties of the plurality of comparable properties, or a combination thereof, according to one or more predicted property valuation metrics, and displaying representations of the subject property, the one or more comparable properties of the plurality of comparable properties, or the combination thereof with markers or labels of different colors, shapes, sizes, or a combination thereof corresponding to different ranks, tiers or classes of properties in a mapped, graphical, or tabular form.

The method may further comprise tracking and calculating valuation metrics of the subject property, the one or more comparable properties of the plurality of comparable properties, or the combination thereof upon detecting the subject property, the one or more comparable properties of the plurality of comparable properties, or the combination thereof listed on internet listing sites, and providing alerts when at least one of one or more predicted property valuation metrics of the subject property, the one or more comparable properties of the plurality of comparable properties, or the combination thereof matches user preferences related to at least one valuation metric of the plurality of valuation metrics. The method may further comprise calculating, by the processor, predicted debt, equity and cashflow growth values over time for the subject property, the one or more comparable properties of the plurality of comparable properties, or the combination thereof, and displaying the predicted debt, equity and cashflow growth values over time in a graphical format, the graphical format comprising a line or stacked area chart, on a display component.

In some embodiments, determining the value of the physical features of a comparable unit may comprise receiving a plurality of images of an interior of the comparable unit, classifying each image into a scene category using a trained neural classifier, detecting, within each classified image, components relevant to property condition using an object-detection model, segmenting regions corresponding to detected components using a segmentation model conditioned on component class, classifying each segmented component into a material or condition category using a trained classifier, generating component-level condition scores using consolidation rules applied across the classified images, and producing the value of the physical features by weighting the component-level scores according to component-specific contribution parameters.

The method may further comprise interactively visualizing property valuations by rendering, on a client device, a scatterplot of financial values versus size, the scatterplot comprising percentile-based curves, receiving user selections or user-defined filters applied to the transactions, and recomputing, on the client device, at least one of a lower band, central-tendency band, or upper band of financial values using curve parameters transmitted to the client and updating the scatterplot accordingly.

The present invention features a computer-implemented method executed by one or more processors for generating an explainable value estimate for a subject real property. The method may further comprise ingesting, into a computer memory, historical transaction records comprising property characteristics, building sizes, locations, and sale prices. The method may further comprise computing time-adjusted prices for the historical transactions by generating a monthly market-value index from non-outlier transactions and applying the index to convert each historical sale price to a current, time-adjusted price. The method may further comprise assigning each transaction to a location group selected from subdivisions, census-based geographic units, or clustered groups exhibiting low internal variance in time-adjusted price. The method may further comprise ranking the location groups by a group-level statistic of time-adjusted price and assigning the groups to percentile-defined tiers. The method may further comprise for each location group, fitting a price-versus-size curve by a rules-based and regression-based algorithm across the full size domain of properties within the group. The method may further comprise computing, for each location group, residual values by dividing each time-adjusted price by a predicted price from the fitted curve. The method may further comprise determining upper and lower percentile-based residual bands across the size domain. The method may further comprise applying the subject property's size to the percentile-based bands or to a percentile-tier fallback curve to generate a subject-specific predicted price range. The method may further comprise interpolating the subject property's predicted value between the upper and lower percentile-based bands according to a system-generated or user-adjusted normalized condition score of the subject property.

The method may further comprise computing the effect of one or more additional value-related components. Computing the effect of one or more additional value-related components may comprise calculating, for each component, a normalized component value for each transaction and the subject property. Computing the effect of one or more additional value-related components may further comprise determining, for each transaction, a residual value by dividing its time-adjusted price by a predicted price from the fitted price-versus-size curve. Computing the effect of one or more additional value-related components may comprise regressing the residual values against differences between the subject property's normalized component value and the normalized component values of the historical transactions to determine a component-specific adjustment to the subject property's predicted value.

The percentile-defined tiers may comprise tiers ranked according to a measure of typical time-adjusted price for each location group. The method may further comprise presenting the ranked economically similar historical transactions to the user as a list of best comparables and generating a subject-property-specific comparable set and corresponding plot using the list. The method may further comprise computing, for each historical transaction, an economic similarity score by summing absolute differences between the subject property's characteristic-related values and corresponding characteristic-related values of the transaction across a plurality of attributes, and using the economic similarity scores to identify a set of economically similar properties. User-directed inclusion or exclusion of transactions from the comparable set results in recomputation of the predicted price range and may use only the included transactions.

The method may further comprise allowing the user to narrow the displayed transactions by applying user-defined filters and updating the predicted price range and selected comparables based on the filtered transactions.

The interpolated subject-property value may be displayed on a scatterplot of transaction prices versus building size, with its vertical position representing the interpolated value and its horizontal position representing the subject property's size. The method may further comprise displaying percentile-based curves on the scatterplot and updating the displayed curves when the set of included comparable transactions changes. The method may further comprise providing a user-selectable toggle to display transaction prices in either time-adjusted form or original sale-price form. The method may further comprise detecting flip transactions by identifying pairs of historical transactions for a same parcel occurring within a predetermined time window and satisfying a price-increase threshold.

The method may further comprise scanning active property listings obtained from one or more remote sources, identifying when a listing price is within a system-generated or user-defined threshold of a system-generated suggested value, and flagging or notifying the user of the listing accordingly. The method may further comprise computing, for each active listing, a predicted value according to the method of claim 1 and displaying a list of active listings sorted by the difference between each listing's asking price and its predicted value. The method may further comprise storing a user-defined profile comprising subject-property information, selected comparable properties, and user adjustments to the subject property's condition. The method may further comprise sharing, electronically with another user, the predicted value along with the component values contributing to the predicted value and the stored user-defined profile.

The present invention features a method for property evaluation. The method may first involve collecting, cleaning and aggregating property and market-wide characteristics and transaction data. Property images in particular are procured from public and/or private sources and passed through a multi-modal image processing pipeline that detects, isolates and grades visible property condition features in a series of parallel and sequential steps that output individual feature grades, which are then further processed into a consolidated condition score for a given property or floorplan.

Numerical and categorical data passes through data processing pipelines that apply filters, outlier removal, regression and residual modeling transformations that are used to measure the direct and indirect relationships between incremental changes in property characteristics such as transaction date, size, age, condition, subdivision, geographic area, lot size, abutting street traffic count, etc. and corresponding incremental changes in property values. Individual properties and transactions are then grouped by various shared characteristics into property groupings. Those property groupings are sorted into cohorts of groupings. Relationships between independent variable value components and price are modeled within these groupings and cohorts of groupings to create additional models relating the group or cohort that a property is in to the relationship between the independent value components of a property and the value of that property.

A simple example of this is grouping subdivided properties into their respective subdivisions, then using the average sale price of each subdivision to further group the subdivisions into cohorts of pricing percentiles, measuring how individual property pricing varies according to property square feet by cohort, and then applying pricing patterns of the cohort to properties within subdivisions of that cohort with minimal transaction history. These model relationships and equations are kept distinct within multiple interrelated models rather than merged into a single or more consolidated model in part to maintain the transparency of the model in such a way that it is explainable to the user throughout the modeling process and through data visualizations later and so that the user will be able to adjust dimension parameters and see the incremental effects of those changes through the user interface.

Using the models and equations described above, each property is assigned a relative value for each value component dimension used in the model. For example, each property has a location value assigned to it based upon its geographic location, and the empirically derived location value of that geographic location. Next, the method involves inputting one or more subject properties by a user or by a scheduled or administratively initiated system generated process such as an Internet search for listed properties.

Each subject property is assigned a value for each contributory value component dimension based upon the system's known information about the property, any additional or modified information input about the property by the user and the model equations used to assign the value for each contributory value component dimension. One or more unifying model-generated equations are then used to convert the individual contributory value components into one or more estimated property values such as likely transaction price in average condition, fully updated condition, poor condition or as a rental income property.

For each subject property input into the system, existing properties and their transactions within the database, or subsets thereof, are compared to the subject property. For each measured value component dimension stored in the database a difference is calculated between the subject property and the existing property. The sum of the absolute differences in contributory values of each subject property and each existing property to which it is compared is calculated. This sum of absolute differences in contributory value components is used as a measure of economic similarity between the subject property and the other properties in the database, with those properties having the least sum of absolute differences being the most economically similar, and those properties having the greatest absolute differences being the least similar. The components of these sums of absolute differences may further be weighted, based upon a systematic empirical analysis, in order to emphasize some value contributing components over others. The component differences may be combined in other ways beyond purely additive to measure economic similarity between properties.

Past property sales or rentals are then ranked by these summed absolute differences, and a set of property sales or rentals with the least absolute differences are presented to the user as most economically similar to the subject property, along with each transacted property's corresponding explainable value component dimension differences and adjustments between it and the subject property. These are commonly referred to as “comparables.”

Data visualization tools such as scatter plots, histograms and other graphic representations of the subject property and economically comparable properties are presented to the user. These tools help the user see how the subject property compares to other economically similar properties along one or more of the value contributing component dimensions. In the example of a price versus square foot plot, additional guidance curves indicate likely maximum, minimum and mid-range values for the subject property.

Additional features allow the user to adjust the subject property characteristics and add or exclude economically comparable transactions and view how those changes impact the predicted likely value of the subject property. While the baseline predictions are typically derived from equations stored in the backend, value and curve changes based upon the user's input are generally processed on the front end and the effects can be viewed nearly instantly.

This method further allows the user to re-rank and display the most economically relevant transactions to find those that are most economically similar to the improved or changed version of the subject property, and re-estimate the value of the subject property with the potential added value of assumed improvements or changes to the property.

The method includes the generation and presentation to the user of visual data representations indicating graphically how the subject property fits in among past property transactions along one or more of the discrete value adding property characteristic component dimensions. This allows the user to gain a more intuitive understanding of the likely property market value and to allow the user to use the user's own judgments about which properties to include or exclude from the value estimation process for the subject property. The method then allows the user to make selective changes to the characteristics of the subject property and to include or exclude specific property transactions from market value estimation calculations.

The method then allows for the property evaluation to be shared electronically with others in an explainable way that breaks down the components comprising the value estimation of the subject property, including changes made by the user.

In some embodiments, the image processing model implemented in the method of the present invention may convert raw images into a normalized condition score. The image processing model may be configured for scene classification to determine the contextual category of each image. The image processing model may be configured for component detection to identify relevant components, including, for example, cabinets, countertops, flooring, and appliances. The image processing model may be configured for conditional segmentation for producing pixel-level segmentation for identified components. The image processing model may be configured for material classification for assigning material or condition categories to each segmented component. The image processing model may be configured for component-level scoring for converting component appearances to scores. The image processing model may be configured for voting and confidence aggregation for aggregating component scores across multiple images. The image processing model may be configured for missing-data modeling for using prior or related-scene inference where components are absent. The image processing model may be configured for calculating an image-indicated condition score by the following equation: q_{img}=Σi wᵢsᵢ. The image processing model may be configured for age adjustment, where age is computed as the difference between transaction date and the year built, and a depreciation function is applied. The image processing model may be configured to age-image reconciliation to determine the finalized condition score.

The present invention may implement a plurality of contributory model equations. For example, for each historical transaction compared to the subject property, the following equation is carried out: pₕ=pₕ+Aₜᵢₘₑ+A_{loc}+A_{size}+A_{cond}+Σₖ Aₖ, where pₕ is the mean property value, pₕ is the base property value, and A represents attributes that contribute to the final property value including age, location, size, condition, and appliances. Aₜᵢₘₑ represents a Monthly Market Value Multiplier (MMVM), calculated as the average price for the current or latest month, divided by the moving average of prices for the month in which the historical transaction occurred, after removing outliers. A_{loc} represents the location value, estimated by the use of residual multipliers or spatial models such as kriging or inverse-distance interpolation.

In some embodiments, the present invention may calculate a similarity-weighted comparable value through the following equations:

$$D ( h , s ) = {\sum }_{k} {α}_{k} \vert {C}_{k} ( h ) - {C}_{k} ( 8 ) \vert$$

$$w ( h ) = \frac{1}{D ( h , s ) + ε}$$

$${P}_{comp} ( s ) = \frac{{\sum }_{h} w ( h ) \underline{{p}_{h}}}{{\sum }_{h} w ( h )}$$

Pricing versus property building size model curves are systematically generated based on calculations related to the distribution of price and square footage values for historical transactions. The simplest example embodiment of this is the calculation of the average slope of the time-adjusted price versus square foot plot of the OLS linear trendline of a set of points representing historical transactions within a subdivision (or other location grouping, cohort of groupings or group of properties economically similar to the subject property). From this example, the percent residuals of each historical transaction (time-adjusted price divided by linear trendline predicted price) are ranked and residual percentiles are calculated. The residual percentiles at 1% and 99% are calculated. Those two values are then multiplied by the linear trendline predicted value at each square foot across the range of building sizes plotted, and then plotted themselves, resulting in expanding bands from left to right on the plot, representing the 1st and 99th percentile of expected pricing at any given point along the range of sizes indicated along the x-axis for the currently displayed points. In other embodiments, pricing and size distribution characteristics unique to each plot are systematically calculated and used to generate more sophisticated curve shapes. The predicted combined condition score of the subject property is then used to interpolate a value at the subject property's building size, between the 1 st and 99 th percentile bands of the displayed historical transactions, as an estimated value of the subject property, having taken into account the location, size and implied condition of the property.

The system outputs multiple value types, including values at improved condition, average condition, user-specified condition, suggested-offer thresholds, rental values, and income-based values using a multiplier applied to estimated net income. The system additionally implements models for generating equations. For example, the subdivision-based curve construction may be calculated through computation of subdivision and other location group level distributions, estimation of slopes for different size regions, estimation of residual price multipliers for location, and derivation of percentile curves for lower and upper guidance bands.

Cohorts may be formed by ranking groupings such as subdivisions by metrics reflecting economic similarity. Cohort-level relationships stabilize curves for subdivisions with limited data. The system may also form groupings based on geographic proximity, floorplan characteristics, building age, traffic exposure, architectural characteristics, or other quantifiable shared features. Component weights may be learned by minimizing prediction error. These weights may emphasize more predictive differences and reduce the influence of less relevant components.

The present invention features a method, in a computer system having a processor, for calculating and displaying an explainable rental rate prediction of one or more subject units of a subject property by isolating a plurality of rental rate value components of the subject property, the plurality of rental rate value components comprising location, size, and one or more physical features. In some embodiments, the method may comprise identifying, from a database comprising data associated with a plurality of properties, a plurality of comparable properties, each comparable property comprising a plurality of comparable units, a known rental value for each unit of the plurality of comparable units, and a plurality of comparable rental rate value components, the plurality of comparable rental rate value components comprising location, size, and one or more physical features. The plurality of comparable properties may comprise a first subset of comparable properties, each comparable property of the first subset comprising two or more units having different sizes, and similar physical features and location, and a second subset of comparable properties, each comparable property of the second subset comprising two or more units having different physical features, and similar size and location; quantifying, by the processor, an effect of size on rental rate based on the first subset of comparable properties.

The method may further comprise determining, by the processor, for each comparable property of the second subset of comparable properties, for each comparable unit, for each physical feature, a value and a weight. The value may be determined based on a quality of the feature. The weight may be determined based on an estimated percentage of which the feature contributes to an overall appeal of the comparable unit. The method may further comprise calculating, by the processor, for each comparable unit of each comparable property of the second subset of comparable properties, an appeal quality scale (AQS) value comprising a sum of a product of the value and the weight of each physical feature of the comparable unit. The method may further comprise quantifying, by the processor, an effect of physical features on rental rate based on the AQS values of the second subset of comparable properties. The method may further comprise deriving, by the processor, based on the effect of size on rental rate and the effect of physical features on rental rate, an effect of location on rental rate. The method may further comprise calculating, by the processor, based on a size of the one or more subject units, one or more physical features of the one or more subject units, a location of the one or more subject units, the effect of size on rental rate, the effect of physical features on rental rate, the effect of location on rental rate, and the known rental value of each unit of the plurality of comparable units of each comparable property of the plurality of comparable properties, a predicted rental rate value of at least one of the one or more subject units of the subject property.

In some embodiments, the plurality of comparable rental rate value components may further comprise age of the property. The plurality of comparable properties may further comprise a third subset of comparable properties, each comparable property of the third subset comprising two or more units having different ages, and similar size, physical features, and location. The method may further comprise quantifying, by the processor, an effect of age on rental rate based on the third subset of comparable properties. Calculating the predicted rental rate value may be further based on the effect of age on rental rate and an age of the one or more subject units. Quantifying the effect of age on rental rate may comprise measuring and averaging differences in rental rates relative to differences in age within one or more groupings of comparable units within the third subset of comparable properties.

In some embodiments, the plurality of comparable rental rate value components may further comprise one or more operational characteristics. The plurality of comparable properties may further comprise a fourth subset of comparable properties, each comparable property of the fourth subset comprising two or more units having different operational characteristics, and similar size, physical features, and location. The method may further comprise quantifying, by the processor, an effect of operational characteristics on rental rate based on the fourth subset of comparable properties. Calculating the predicted rental rate value may be further based on the effect of operational characteristics on rental rate and one or more operational characteristics of the one or more subject units. Quantifying the effect of operational characteristics on rental rate comprises, for each operational characteristic of the one or more operational characteristics, measuring and averaging differences in rental rates relative to differences in the operational characteristic within one or more groupings of comparable units within the fourth subset of comparable properties. In some embodiments, the one or more operational characteristics may comprise form and quality of property management, maintenance, customer service, offered resident services, communication quality and channels between residents and property management, advertising, marketing, sales practices, pricing strategy, promotions, retention programs, concessions, resident rewards programs, or a combination thereof.

The plurality of comparable rental rate value components may further comprise one or more online reputation characteristics. The plurality of comparable properties may further comprise a fifth subset of comparable properties, each comparable property of the fifth subset comprising two or more units having different online reputation characteristics, and similar size, physical features, and location. The method may further comprise quantifying, by the processor, an effect of online reputation characteristics on rental rate based on the fifth subset of comparable properties. Calculating the predicted rental rate value may be further based on the effect of online reputation characteristics on rental rate and one or more online reputation characteristics of the one or more subject units. Quantifying the effect of online reputation characteristics on rental rate may comprise, for each online reputation characteristic of the one or more online reputation characteristics, measuring and averaging differences in rental rates relative to differences in the online reputation characteristic within one or more groupings of comparable units within the fifth subset of comparable properties. The one or more online reputation characteristics may comprise quantitative and qualitative measures of online reviews, ratings and presence among internet rental or sales listing sites or advertising sites, or a combination thereof.

In some embodiments, quantifying the effect of size on rental rate may comprise calculating, by the processor, for each comparable property of the first subset of comparable properties, a rental rate per square foot value based on the size and the known rental value of each unit of the plurality of comparable units. Quantifying the effect of size on rental rate may further comprise calculating, by the processor, a best-fit equation for two or more comparable units of each comparable property of the first subset of comparable properties relating the rental rate per square foot value to the size.

Quantifying the effect of size on rental rate may further comprise calculating, by the processor, an average best-fit equation approximating a weighted average of the best-fit equations for the comparable units of each property of the first subset of comparable properties. A weight of each best-fit equation of each property may be based on a number of units from which each best-fit equation is derived. The effect of size on rental rate may be calculated by inputting the size of each subject unit of the at least one of the one or more subject units into the average best-fit equation.

In some embodiments, determining, for each comparable property of the second subset of comparable properties, for each comparable unit, for each physical feature, the value may comprise analyzing one or more images of the physical feature by human analysis, computer vision, or a combination thereof. Quantifying an effect of physical features on rental rate may comprise selecting, by the processor, a pair of comparable units r1 and r2 within a comparable property of the second subset, such that an AQS value of r1, AQS1, is less than an AQS value for r2, AQS2. Quantifying an effect of physical features on rental rate may further comprise calculating, by the processor, intermediate predicted rental rates for r1 and r2 based on the effect of size on rental rate. Quantifying an effect of physical features on rental rate may further comprise subtracting, by the processor, the intermediate predicted rental rate for r1 from the known rental value of r1, resulting in a difference d1. Quantifying an effect of physical features on rental rate may further comprise subtracting, by the processor, the intermediate predicted rental rate for r2 from the known rental value of r2, resulting in a difference d2. Quantifying an effect of physical features on rental rate may further comprise calculating, by the processor, a rate of change in rental rate with respect to a change in AQS value, by subtracting d1 from d2, resulting in a difference d3, and dividing d3 by a difference resulting from subtracting AQS1 from AQS2, resulting in a value of rental rate per AQS value. Quantifying an effect of physical features on rental rate may further comprise repeating this process for each pair of comparable units of each comparable property of the second subset.

Quantifying an effect of physical features on rental rate may further comprise averaging, by the processor, the values of rental rate per AQS value for each pair of comparable units of each comparable property of the second subset, resulting in a General AQS Value (GAV). The GAV may represent an estimated additional value contributed to unit rental rate if a rental unit was completely updated as compared to if the rental unit was completely outdated. Quantifying an effect of physical features on rental rate may further comprise averaging, by the processor, the AQS values of the comparable units of the second subset of comparable properties, resulting in an average AQS value. Quantifying an effect of physical features on rental rate may further comprise calculating, by the processor, based on the GAV, the average AQS value, and the AQS value of the at least one of the one or more subject units of the subject property, the effect of physical features on rental rate.

In some embodiments, deriving the effect of location on rental rate may comprise predicting, by the processor, intermediate rental rates for each comparable unit of each comparable property based on the effect of size on rental rate, and the effect of physical features on rental rate. Deriving the effect of location on rental rate may further comprise measuring, by the processor, for each comparable unit of each comparable property, a residual error by calculating a difference of the intermediate rental rate from the known rental value. Deriving the effect of location on rental rate may further comprise storing, by the processor, for each comparable unit of each comparable property, the residual error and location coordinates of the comparable unit in a structured data format. Deriving the effect of location on rental rate may further comprise incorporating, by the processor, for each comparable unit of each comparable property, one or more additional predictor variables to the structured data format, the one or more additional predictor variables comprising economic data of an area surrounding the location, demographic data of the area surrounding the location, crime rates of the area surrounding the location, familial status data of the area surrounding the location, distance from the location to one or more key locations of interest, or a combination thereof. Deriving the effect of location on rental rate may further comprise applying, by the processor, one or more spatial modeling and geostatistical algorithms to the structured data format to determine the effect of location on rental rate, the one or more spatial modeling and geostatistical algorithms comprising kriging, inverse distance multiplied by a constant and raised to an exponent, or a combination thereof.

In some embodiments, calculating the predicted rental rate value of the at least one of the one or more subject units of the subject property may comprise applying, for each comparable unit of each comparable property of the plurality of comparable properties relative to the subject unit, for each comparable rental rate value component of the plurality of comparable rental rate value components, a differential value based on the comparable rental rate value component compared to a corresponding rental rate value component of the subject unit. Calculating the predicted rental rate value of the at least one of the one or more subject units of the subject property may further comprise summing, for each comparable unit of each comparable property of the plurality of comparable properties, the differential values of the plurality of comparable rental rate value components resulting in a sum of differential values. Calculating the predicted rental rate value of the at least one of the one or more subject units of the subject property may further comprise adding, for each comparable unit of each comparable property of the plurality of comparable properties, the sum of differential values to the known rental rate of the comparable unit, resulting in an intermediate predicted rental rate value for the subject unit based upon the comparable unit. Calculating the predicted rental rate value of the at least one of the one or more subject units of the subject property may further comprise calculating an average of the plurality of intermediate predicted rental rate values resulting in the predicted rental rate value of the at least one of the one or more subject units of the subject property.

In some embodiments, the method may further comprise adding the predicted rental rate value to the database. In some embodiments, the method may further comprise comparing the predicted rental rate value to the known rental rates of the plurality of comparable properties and an effect of each rental rate value component on rental rates. In some embodiments, the method may further comprise iteratively adjusting the effect of each rental rate value component on rental rates such that a difference between the predicted rental rate value and the known rental rates is minimized. In some embodiments, iteratively adjusting the effect of each rental rate value component may comprise adjusting the effects of the individual physical features on the final AQS score for a unit.

The predicted rental rate value of the at least one of the one or more subject units of the subject property may be further based on a manual adjustment from a user. The manual adjustment may comprise an addition of value or a subtraction of value applied to an intermediate predicted rental rate value of the plurality of intermediate predicted rental rate values, the predicted rental rate value, or a combination thereof, selection or deselection of one or more intermediate predicted rental rate values of the plurality of intermediate predicted rental rate values from calculating the average, filtering the plurality of comparable properties by the plurality of comparable rental rate value components, or a combination thereof.

In some embodiments, the method may further comprise displaying, by the processor, the plurality of comparable units of the plurality of comparable properties on a display component such that the plurality of comparable units are sorted into a list such that comparable units most similar to the subject unit are earlier in the list by a sorting method. The sorting method may comprise calculating, for each comparable rental rate value component of a comparable unit of the plurality of comparable units, a differential value based on the comparable rental rate value component compared to a corresponding rental rate value component of the subject unit and an effect of the corresponding rental rate value component on rental rate. The sorting method may further comprise summing an absolute value of each differential value into a sum of absolute differences. The sorting method may further comprise repeating this process for each comparable unit of the plurality of comparable units of the plurality of comparable properties. The sorting method may further comprise sorting the plurality of comparable units of the plurality of comparable properties by the sum of absolute differences of each comparable unit. The list may comprise the plurality of comparable units. In some embodiments, the method may further comprise displaying, by the processor, the plurality of comparable units of the plurality of comparable properties on a display component such that the plurality of comparable units are filtered, sorted, or a combination thereof by a number of physical features.

In some embodiments, the method may further comprise calculating, by the processor, a predicted net operating income of the subject property. Calculating the predicted net operating income may comprise calculating, by the processor, for each subject unit of the subject property, the predicted rental rate value. Calculating the predicted net operating income may further comprise adding, by the processor, the predicted rental rate value of each subject unit of the subject property or of the subject property as a whole, resulting in a gross rents value. Calculating the predicted net operating income may further comprise subtracting, by the processor, a percentage of the gross rents value representing estimated loss to lease, vacancy, concessions, delinquency and other negative operating revenue adjustments. Calculating the predicted net operating income may further comprise adding a percentage of the gross rents value representing additional sources of revenue including estimated utility reimbursements, equipment rentals, pet rents and deposits, parking revenue, application fees, collections, late charges, lease break fees, and other positive operating revenue adjustments, or a combination thereof to the gross rents value, resulting in an effective gross income value.

Calculating the predicted net operating income may further comprise estimating, by the processor, based on the location of the subject property, a tax expense for the subject property. Calculating the predicted net operating income may further comprise estimating, by the processor, based on insurance data of the plurality of comparable properties, an insurance expense for the subject property. Calculating the predicted net operating income may further comprise estimating, by the processor, a payroll expense for the subject property. Calculating the predicted net operating income may further comprise estimating, by the processor, a utility expense for the subject property. Calculating the predicted net operating income may further comprise estimating, by the processor, a repair and maintenance expense for the subject property. Calculating the predicted net operating income may further comprise estimating, by the processor, a property management fee expense for the subject property. Calculating the predicted net operating income may further comprise estimating, by the processor, an advertising, marketing and administrative expense for the subject property. Calculating the predicted net operating income may further comprise calculating, by the processor, based on the effective gross income, the tax expense, the insurance expense, the payroll expense, the utility expense, the repair and maintenance expense, the property management fee expense, and the advertising, marketing and administrative expense, the predicted net operating income of the subject property.

In some embodiments, the method may further comprise calculating, by the processor, a revised predicted net operating income and a predicted project cost associated with one or more hypothetical value-adding improvements to the at least one subject unit of the one or more subject units of the subject property. Calculating the revised predicted net operating income and a predicted project cost may comprise calculating, by the processor, based on the effect of physical features on rental rate and known operating expense values, a revised estimated net operating income for the subject property as a result of an addition of the one or more hypothetical value-adding improvements not present in the at least one subject unit of the one or more subject units of the subject property. Calculating the revised predicted net operating income and a predicted project cost may further comprise calculating, by the processor, for each hypothetical value-adding improvements of the one or more hypothetical value-adding improvements, a construction cost comprising a cost of materials, a cost of labor, a cost of design, a cost of permitting, a cost of utilities, a cost of insurance, and a cost of non-revenue producing time of the at least one subject unit during construction. Calculating the revised predicted net operating income and a predicted project cost may further comprise calculating, by the processor, based on an added value of the one or more hypothetical value-adding improvements and the construction cost of each hypothetical value-adding improvements of the one or more new physical features, the revised predicted net operating income and the predicted project cost.

In some embodiments, the method may further comprise calculating, by the processor, a predicted loan rate of the subject property. Calculating the predicted loan rate may comprise estimating, by the processor, based on a set of current market data from a market data database, a size of a loan likely to be approved for the subject property. Calculating the predicted loan rate may further comprise estimating, by the processor, based on the set of current market data, an interest rate of the loan. Calculating the predicted loan rate may further comprise estimating, by the processor, based on the set of current market data, a term and amortization schedule for the loan. Calculating the predicted loan rate may further comprise estimating, by the processor, based on the set of current market data, a frequency of payments of the loan. Calculating the predicted loan rate may further comprise estimating, by the processor, based on the set of current market data, fees of the loan. Calculating the predicted loan rate may further comprise calculating, by the processor, based on the size of the loan, the interest rate, the term and amortization schedule, the frequency of payments, and the loan fees, the predicted loan rate of the subject property.

In some embodiments, the method may further comprise calculating, by the processor, with and without the one or more hypothetical value-adding improvements, one or more predicted property valuation metrics including a predicted pro forma revenue, one or more expense line items, gross rents, effective gross income, operating expenses, operating expense ratio, net operating income, gross rent multiplier, capitalization rate, estimated resale value, loan to value ratio, debt service coverage ratio, yield on cost, debt service, cashflow, total project cost, profit potential, maximum recommended offer amount, price per square foot, return on investment, cash-on-cash return, internal rate of return or a combination thereof. In some embodiments, the method may further comprise filtering, sorting, stratifying or classifying, by the processor, the subject property, one or more comparable properties of the plurality of comparable properties, or a combination thereof, according to one or more predicted property valuation metrics, and displaying representations of the subject property, the one or more comparable properties of the plurality of comparable properties, or the combination thereof with markers or labels of different colors, shapes, sizes, or a combination thereof corresponding to different ranks, tiers or classes of properties in a mapped, graphical, or tabular form.

In some embodiments, the method may further comprise tracking and calculating valuation metrics of the subject property, the one or more comparable properties of the plurality of comparable properties, or the combination thereof upon detecting the subject property, the one or more comparable properties of the plurality of comparable properties, or the combination thereof listed on internet listing sites, and providing alerts when at least one of one or more predicted property valuation metrics of the subject property, the one or more comparable properties of the plurality of comparable properties, or the combination thereof matches user preferences related to at least one valuation metric of the plurality of valuation metrics. In some embodiments, the method may further comprise calculating, by the processor, predicted debt, equity and cashflow growth values over time for the subject property, the one or more comparable properties of the plurality of comparable properties, or the combination thereof, and displaying the predicted debt, equity and cashflow growth values over time in a graphical format, the graphical format comprising a line or stacked area chart, on a display component.

The present invention features a method, in a computer system having a processor, for calculating and displaying an explainable rental rate prediction of one or more subject units of one or more subject properties by isolating a plurality of rental rate value components comprising location, size, age, one or more operational characteristics, one or more online reputation characteristics and one or more physical features. In some embodiments, the method may comprise identifying, from a database comprising data on a plurality of properties, a plurality of comparable properties proximate in location to the subject property, each comparable property comprising a plurality of comparable units, a known rental value for each unit of the plurality of comparable units, and a plurality of comparable rental rate value components, the plurality of comparable rental rate value components comprising location, size, age, one or more physical features, one or more operational characteristics, and one or more online reputation characteristics.

In some embodiments, the plurality of comparable properties may comprise a first subset of comparable properties, with each property in this first subset comprising two or more units of differing sizes, but of the same or similar location, age, operational characteristics, online reputation characteristics and physical features. The plurality of comparable properties may further comprise a second subset of comparable properties, with each property in this second subset comprising two or more units of differing physical features, but of the same or similar location, size, age, operational characteristics and online reputation characteristics. The plurality of comparable properties may further comprise a third subset of comparable units, with each property in this third subset comprising two or more units of differing age, but of the similar location, size, physical features, operational characteristics and online reputation characteristics. The plurality of comparable properties may further comprise a fourth subset of comparable properties, with each grouping within this fourth subset comprising two or more units of differing operational characteristics, but of the same or similar location, size, age, physical features, and online reputation characteristics. The plurality of comparable properties may further comprise a fifth subset of comparable properties, with each grouping within this fifth subset comprising two or more units of differing online reputation characteristics, but of the same or similar location, size, age, physical features and operational characteristics.

The method may further comprise quantifying, by the processor, an effect of size on rental rate based on the first subset of comparable properties. The method may further comprise determining, by the processor, for each comparable property of the second subset of comparable properties, for each comparable unit, for each physical feature, a value and a weight. The value may be determined based on a quality of the feature. The weight may be determined based on an estimated percentage of which the feature contributes to an overall appeal of the comparable unit. The method may further comprise calculating, by the processor, for each comparable unit of each comparable property of the second subset of comparable properties, an appeal quality scale (AQS) value comprising a sum of a product of the value and the weight of each physical feature of the comparable unit. The method may further comprise quantifying, by the processor, an effect of physical features on rental rate based on the AQS values of the second subset of comparable properties.

The method may further comprise quantifying, by the processor, an effect of age on rental rate. The method may further comprise quantifying, by the processor, an effect of operational characteristics on rental rate. The method may further comprise quantifying, by the processor, an effect of online reputation characteristics on rental rate. The method may further comprise deriving, by the processor, based on the effect of size on rental rate, the effect of physical features on rental rate, the effect of operational characteristics on rental rate, the effect of online reputation characteristics on rental rate and the effect of age on rental rate, an effect of location on rental rate. The method may further comprise calculating, by the processor, based on a size of the one or more subject units, one or more physical features of the one or more subject units, one or more operational characteristics of the one or more subject units, one or more online reputation characteristics of the one or more subject units, an age of the one or more subject units, a location of the one or more subject units, the effect of size on rental rate, the effect of physical features on rental rate, the effect of operational characteristics on rental rate, the effect of online reputation characteristics on rental rate, the effect of age on rental rate, the effect of location on rental rate, and the known rental value of each unit of the plurality of comparable units of each comparable property of the plurality of comparable properties, a predicted rental rate value of at least one of the one or more subject units of the subject property.

In some embodiments, quantifying, by the processor, for each operational characteristic of the one or more operational characteristics, an effect of the operational characteristic on rental rate based on the fourth subset of comparable properties. In some embodiments, calculating the predicted rental rate value may be further based on the effect of the operational characteristic on rental rate for each operational characteristic of the one or more operational characteristics. In some embodiments, the one or more operational characteristics may comprise form and quality of property management, maintenance, customer service, offered resident services, communication quality and channels between residents and property management, advertising, marketing, sales practices, pricing strategy, promotions, retention programs, concessions, resident rewards programs, or a combination thereof.

In some embodiments, quantifying, by the processor, for each online reputation characteristic of the one or more online reputation characteristics an effect of the online reputation characteristics on rental rate based on the fifth subset of comparable properties. In some embodiments, calculating the predicted rental rate value may be further based on the effect of online reputation characteristics on rental rate for each online reputation characteristic of the one or more online reputation characteristics. In some embodiments, the one or more online reputation characteristics may comprise quantitative and qualitative measures of online reviews, ratings and presence among internet rental or sales listing sites or advertising sites, or a combination thereof by measuring and averaging differences in rental rates relative to differences in online reputation characteristics within each grouping of comparable units within the fifth subset of comparable properties

In some embodiments, quantifying the effect of size on rental rate may comprise calculating, by the processor, for each comparable property of the first subset of comparable properties, a rental rate per square foot value based on the size and the known rental value of each unit of the plurality of comparable units. This method may further comprise calculating, by the processor, a best-fit equation for two or more comparable units of each comparable property of the first subset of comparable properties relating the rental rate per square foot value to the size. This method may further comprise calculating, by the processor, an average best-fit equation approximating a weighted average of the best-fit equations of two or more comparable units of each property of the first subset of comparable properties. The weight of each best-fit equation of each comparable property may be based on the number of units from which each best-fit equation is derived. The effect of size on rental rate may be calculated by inputting the size of each subject unit of the at least one of the one or more subject units into the average best-fit equation. In some embodiments, determining, for each comparable property of the second subset of comparable properties, for each comparable unit, for each physical feature, the value may comprise analyzing one or more images of the physical feature by human analysis, computer vision, or a combination thereof.

In some embodiments, quantifying an effect of physical features on rental rate may comprise selecting, by the processor, a pair of comparable units r1 and r2 within a comparable property of the second subset, such that an AQS value of r1, AQS1, is less than an AQS value for r2, AQS2. This method may further comprise calculating, by the processor, intermediate predicted rental rates for r1 and r2 based on the effect of size on rental rate. This method may further comprise subtracting, by the processor, the intermediate predicted rental rate for r1 from the known rental value of r1, resulting in a difference d1. This method may further comprise subtracting, by the processor, the intermediate predicted rental rate for r2 from the known rental value of r2, resulting in a difference d2. This method may further comprise calculating, by the processor, a rate of change in rental rate with respect to a change in AQS value, by subtracting d1 from d2, resulting in a difference d3, and dividing d3 by a difference resulting from subtracting AQS1 from AQS2, resulting in a value of rental rate per AQS value. This method may further comprise repeating the previous steps for each pair of comparable units of each comparable property of the second subset. This method may further comprise averaging, by the processor, the values of rental rate per AQS value for each pair of comparable units of each comparable property of the second subset, resulting in a General AQS Value (GAV). The GAV may represent an estimated additional value contributed to unit rental rate if a rental unit was completely updated as compared to if the rental unit was completely outdated. This method may further comprise averaging, by the processor, the AQS values of the comparable units of the second subset of comparable properties, resulting in an average AQS value. This method may further comprise calculating, by the processor, based on the GAV, the average AQS value, and the AQS value of the at least one of the one or more subject units of the subject property, the effect of physical features on rental rate.

In some embodiments, deriving the effect of location on rental rate may comprise predicting, by the processor, intermediate rental rates for each comparable unit of each comparable property based on the effect of size on rental rate, the effect of physical features on rental rate, the effect of age on rental rate, the effect of operational characteristics on rental rate and the effect of online reputation characteristics on rental rate. This method may further comprise measuring, by the processor, for each comparable unit of each comparable property, a residual error by calculating a difference of the intermediate rental rate from the known rental value. This method may further comprise storing, by the processor, for each comparable unit of each comparable property, the residual error and location coordinates of the comparable unit in a structured data format. This method may further comprise incorporating, by the processor, for each comparable unit of each comparable property, one or more additional predictor variables to the structured data format, the one or more additional predictor variables comprising economic data of an area surrounding the location, demographic data of the area surrounding the location, crime rates of the area surrounding the location, familial status data of the area surrounding the location, distance from the location to one or more key locations of interest, or a combination thereof. In some embodiments, this method may further comprise applying, by the processor, one or more spatial modeling and geostatistical algorithms to the structured data format to determine the effect of location on rental rate, the one or more spatial modeling and geostatistical algorithms including kriging, inverse distance multiplied by a constant and raised to an exponent, or a combination thereof.

In some embodiments, the method may further comprise identifying, by the processor, a new plurality of comparable properties, and recalibrating the effect of size on rental rate, the effect of physical features on rental rate, the effect of age on rental rate, the effect of operational characteristics on rental rate, the effect of online reputation characteristics on rental rate, the effect of location on rental rate, or a combination thereof based on the new plurality of comparable properties. In some embodiments, calculating the predicted rental rate value of the at least one of the one or more subject units of the subject property may comprise applying to the known rental rate of each comparable unit of each comparable property of the plurality of comparable properties relative to the subject unit, the differential effect of size on rental rate, the differential effect of physical features on rental rate, the differential effect of age on rental rate, the differential effect of operational characteristics on rental rate, the differential effect of online reputation characteristics on rental rate, and the effect of location on rental rate resulting in a plurality of intermediate predicted rental rate values, and averaging the plurality of intermediate predicted rental rate values resulting in the predicted rental rate value of the at least one of the one or more subject units of the subject property.

In some embodiments, the method may further comprise displaying, by the processor, the plurality of comparable units of the plurality of comparable properties on a display component such that the plurality of comparable units are sorted so that the comparable units most similar to the subject unit are on top by first calculating each rental rate value component for the subject unit, then by calculating each rental rate value component for one comparable unit, then by calculating the absolute difference between each value component for the subject unit and the comparable unit, then by summing absolute differences for all rental rate value components, and then by repeating this process for each comparable unit, and then by sorting all comparable units such that the comparable units with the smallest sum of absolute differences are on top and the comparable units with the largest absolute differences are on the bottom, with a finite number of the top comparables being displayed. In some embodiments, the method may further comprise displaying, by the processor, the plurality of comparable units of the plurality of comparable properties on a display component such that the plurality of comparable units are filtered and/or sorted by a number of physical features.

In some embodiments, the method may further comprise calculating, by the processor, a predicted net operating income of at least one subject property. Calculating the predicted net operating income may comprise predicting rental rates for one or more of the units of the subject property based upon the plurality of rental rate value components comprising location, size, age, one or more operational characteristics, one or more online reputation characteristics and one or more physical features of the units. Calculating the predicted net operating income may further comprise calculating a gross rents value for the subject property by adding together all of the predicted rental rates for all of the units of the subject property, if sufficient individual unit information is known. Calculating the predicted net operating income may further comprise otherwise calculating a gross rent value for the subject property, if insufficient individual units information is unknown, by predicting a total rental rate for the subject property as a whole based upon the plurality of rental rate value components comprising location, total property livable area size, age, one or more operational characteristics, one or more online reputation characteristics and one or more physical features of the property.

Calculating the predicted net operating income may further comprise calculating an effective gross income value by subtracting from the gross rents value a percentage of the gross rents value for estimated loss to lease, vacancy, concessions, delinquency and other negative operating revenue adjustments and then adding to the effective gross rents as a percentage of the gross rents value for additional sources of revenue including estimated utility reimbursements, equipment rentals, pet rents and deposits, parking revenue, application fees, collections, late charges, lease break fees and other positive revenue adjustments. Calculating the predicted net operating income may further comprise estimating, by the processor, based on the location of the subject property, a tax expense for the subject property. Calculating the predicted net operating income may further comprise estimating, by the processor, based on insurance data of the plurality of comparable properties, an insurance expense for the subject property. Calculating the predicted net operating income may further comprise estimating, by the processor, a payroll expense for the subject property.

Calculating the predicted net operating income may further comprise estimating, by the processor, a utility expense for the subject property. Calculating the predicted net operating income may further comprise estimating, by the processor, a repair and maintenance expense for the subject property. Calculating the predicted net operating income may further comprise estimating, by the processor, a property management fee expense for the subject property. Calculating the predicted net operating income may further comprise estimating, by the processor, advertising, marketing and administrative expense for the subject property. Calculating the predicted net operating income may further comprise calculating, by the processor, based on the effective gross income, reduced by the operating expenses of the tax expense, the insurance expense, the payroll expense, the utility expense, the repair and maintenance expense, the property management fee expense, and the advertising, marketing and administrative expenses, the predicted net operating income of the subject property.

In some embodiments, the method may further comprise calculating, by the processor, a revised predicted value-add net operating income and a predicted value-add project cost associated with hypothetical value-adding improvements to at least one subject unit of the one or more subject units of the subject property. Calculating the revised predicted net operating income and a predicted project cost associated with hypothetical value-adding improvements may comprise calculating, by the processor, based on the effect of physical features, operational characteristics and/or online reputation characteristics on rental rates and operating expenses, a revised estimated net operating income for the subject property due to the addition of one or more new physical features, operational characteristics or online reputation characteristics not present in or for the at least one subject unit of the one or more subject units of the subject property.

Calculating the revised predicted net operating income and a predicted project cost associated with hypothetical value-adding improvements may further comprise calculating, by the processor, for each new physical feature of the one or more new physical features, a construction cost comprising a cost of materials, and a cost of labor, a cost of design, permitting, utilities, insurance and other construction-related costs and a cost of non-revenue producing time of the one or more subject units during construction or renovation. Calculating the revised predicted net operating income and a predicted project cost associated with hypothetical value-adding improvements may further comprise calculating, by the processor, based on the added value of the one or more new physical features, operational characteristics and/or online reputation characteristics, and the construction cost of each new physical feature of the one or more new physical features, the revised predicted value-add net operating income and a predicted value-add project cost associated with hypothetical value-adding improvements.

In some embodiments, the method may further comprise calculating, by the processor, a predicted loan rate of the subject property. Calculating the predicted loan rate may comprise estimating, by the processor, based on a set of current market data from a market data database, a size of a loan likely to be approved for the subject property. Calculating the predicted loan rate may further comprise estimating, by the processor, based on the set of current market data, an interest rate of the loan. Calculating the predicted loan rate may further comprise estimating, by the processor, based on the set of current market data, a term and amortization schedule for the loan. Calculating the predicted loan rate may further comprise estimating, by the processor, based on the set of current market data, a frequency of payments of the loan. Calculating the predicted loan rate may further comprise estimating, by the processor, based on the set of current market data, the fees of the loan. Calculating the predicted loan rate may further comprise calculating, by the processor, based on the size of the loan, the interest rate, the term and amortization schedule, the frequency of payments, and the loan fees, the predicted debt service payments and loan costs of the subject property.

In some embodiments, the method may further comprise calculating, by the processor, with and without added hypothetical value-adding improvements, predicted property valuation metrics including predicted proforma revenue and expense line items, gross rents, effective gross income, operating expenses, operating expense ratio, net operating income, gross rent multiplier, capitalization rate, estimated resale value, loan to value ratio, debt service coverage ratio, yield on cost, debt service, cashflow, total project cost, profit potential, maximum recommended offer amount, price per square foot, return on investment, cash-on-cash return and internal rate of return.

In some embodiments, the predicted rental rate value of the at least one of the one or more subject units of the subject property may be further based on a manual adjustment from a user. In some embodiments, the predicted operational income may be further based on a manual adjustment from the user. In some embodiments, adjustments may consist of additions or subtractions of value to one or more comparable unit rental rates or the subject unit rental rate, selection or deselection of specific comparable units, or filtering by specific ranges or values of physical features, operational characteristics, online reputation characteristics, location, size or age. In other embodiments, the predicted line item revenue values, expense item values, expense ratios, capitalization rates, loan interest rates and terms, value-add improvement line item costs, investor assumptions, future revenue and expense growth trends and assumptions, and valuation metric thresholds may be further based on a manual adjustment from the user.

The present invention features a method for calculating and displaying explainable rental rate predictions by isolating rental rate value components, including but not limited to components such as location, size, age, physical improvements and features. This method may comprise a method for isolating and quantifying that portion of rental rate predictions for one or more rental units attributable to unit size by determining the generalized relationship between unit size and unit rental rate for a set of rental units. This method may comprise Identifying subsets (“Size Subsets”) of rental units that share similar features and location coordinates, but differ in size, in order to control for variables other than rental unit size. This method may further comprise calculating a best-fit equation (“Size Subset Equation”) for each such Size Subset of rental units relating rental rates per square foot to unit size. This method may further comprise calculating an average function (“Average Best-Fit Equation”) approximating the weighted average of all equations for all Size Subsets calculated in the previous step, weighted by the number of rental units within each Size Subset. This method may further comprise Inputting a unit size of one or more rental units for which rental rates are being predicted into the Average Best-Fit Equation from the previous step to predict the rental rate value component attributable to rental unit size for one or more rental units. This method may further comprise displaying the portion of the rental rate value attributable to unit size for one or more rental units.

The method for calculating and displaying explainable rental rate predictions may further comprise a method for isolating and quantifying that portion of rental rate predictions for one or more rental units attributable to unit and property physical features, quality and condition, other than rental unit size and rental unit location. This method may comprise forming a list of discrete qualitative and quantitative physical features (Features List) of rental units that have an impact on rental rates, such as finishes, fixtures and the quality and condition of those features. This method may further comprise defining a range of boolean values of 0 or 1 or graduated scale values (Feature Values) for each member of the Features List, with corresponding definitions for each Feature Value of each Feature List member, with each Feature Value being an indicator of whether each Feature List member is more or less modern and appealing for a given rental unit than for a rental unit of average age and condition among the rental units being evaluated.

This method may further comprise providing a weight for each discrete feature between 0 and 1 (Feature Weight) such that the Feature Weight reflects an estimated percentage of which the corresponding feature contributes to the overall appeal quality of a typical rental unit based upon the rental unit's discrete qualitative and quantitative physical features and such that the sum of all Feature Weights equal 1.00. This method may further comprise examining and analyzing one or more images of each rental unit, and thereby making a determination of and assigning an appropriate Feature Value according to the predetermined corresponding definition of each Feature Value for each member of the Feature List and for each rental unit, either manually by one or more human users of this method, or by use of one or more computer vision applications. This method may further comprise adding together the product of each Feature Weight and each Feature Value for each member of the Feature List for a given rental unit and storing the sum of the products as one Appeal Quality Score (AQS) ranging in value from 0 to 1 for that rental unit, where a 0 would be indicative of a completely outdated rental unit and a 1 would be indicative of a new or “like new” rental unit. This method may further comprise identifying subsets (“Feature Subsets”) of rental units that share similar locations, such as within the same property, but differ in AQS values.

This method may further comprise calculating the incremental increase in rental rate corresponding to an increase in AQS value. Calculating the incremental increase may comprise selecting one pair of unique rental units “r1” and “r2” within each Feature Subset, such that the AQS value for r1, “AQS1”, is less than the AQS value for r2, “AQS2.” Calculating the incremental increase may further comprise calculating intermediate predicted rental rates by unit size alone for r1 and r2 using the previously calculated Size Subset Equation, if available for the pair, or else using the Average Best-Fit Equation. Calculating the incremental increase may further comprise subtracting the intermediate predicted rent for r1 based upon r1 unit size from the actual rent of r1, resulting in difference “d1.” Calculating the incremental increase may further comprise subtracting the intermediate predicted rent for r2 based upon r2 unit size from the actual rent of r2, resulting in difference “d2.”

Calculating the incremental increase may further comprise calculating the rate of change in rental rate with respect to the change in AQS value, by subtracting d1 from d2 and dividing that difference by the difference of subtracting AQS1 from AQS2, resulting in a value per AQS. Calculating the incremental increase may further comprise repeating this calculation to calculate the value per AQS rate for each pair of each Feature Subset. Calculating the incremental increase may further comprise averaging the $value per AQS rate for all pairs for all Feature Subsets, to establish a General AQS Value (“GAV”), such that the GAV represents the estimated additional value contributed to a unit rental rate if that rental unit were completely updated as compared to if that same rental unit were completely outdated.

The method for isolating and quantifying the portion of rental rate predictions for one or more rental units attributable to unit and property physical features may further comprise multiplying the GAV of a rental unit for which a rental rate is being predicted by the difference of subtracting the AQSavg from the AQS value for that rental unit, yielding the estimated rental rate value component attributable to AQS for that rental unit. This method may further comprise storing and displaying the portion of the rental rate value attributable to AQS for one or more rental units.

The present invention features a method for isolating and quantifying that portion of rental rate predictions for one or more rental units attributable to other specific attributes of the rental unit, such as age, property amenities, exterior features, online reputation and ratings, property management methods, form and quality of property management, maintenance, customer service, offered resident services, communication quality and channels between residents and property management, pricing strategy, promotions, retention programs, concessions, resident rewards programs, or a combination thereof, by selecting subsets of rental units where one selected attribute varies while most or all other attributes are the same or similar so that changes in the selected attribute can be isolated, measured and correlated with changes in rental rates.

The present invention features a method for isolating and quantifying that portion of rental rate predictions for one or more rental units attributable to location coordinates. The method may comprise predicting rental rates for each rental unit by adding together or otherwise combining one or more of the rental rate value components described above, such as in an empirically derived equation containing one term for each rental rate value component. The method may further comprise measuring the residual error by calculating the difference of subtracting predicted rental rates from actual rental rates for each rental unit. The method may further comprise storing the residual error, along with the x and y coordinates, for each rental unit in a structured data format as “Location Values.” The method may further comprise adding other predictor variables to the structured data format, such as economic or demographic data, crime rates, familial status, distances and/or drive times to key locations of interest, such as grocery stores, schools, employers, etc. The method may further comprise applying one or more of a plurality of spatial modeling and geostatistical techniques including, but not limited to kriging and inverse distance squared, to use known Location Values at specified x, y coordinates, or geographic areas with known average Location Values, to predict unknown Location Values of other x, y coordinates or geographic areas. The method may further comprise storing and displaying the portion of the rental rate value attributable to Location Value for one or more rental units.

The overall method of the present invention may comprise adding together, or otherwise combining in an empirically derived mathematical equation, rental rate component values for unit size, AQS, other rental unit attributes and Location Values, to calculate a total rental rate prediction value. The overall method of the present invention may comprise iteratively recalibrating the weights and values of rental rate value components to improve the overall predictive accuracy of the model using various forms of machine learning. The overall method of the present invention may comprise storing and displaying rental rate prediction values and/or the rental rate component values for one or more rental units, individually or collectively.

The present invention may feature a method to identify and sort comparable rental units and properties so that the comparable rental units are listed from the least to greatest sum of the absolute value of the differences in component rental rate values. The present invention may feature a method to allow users to interactively select, and de-select and make manual adjustments to rental comparables for calculations of predicted rent for a subject rental property, with and without additional contemplated value-add improvements. The present invention may feature a method to allow users to compare and sort units by feature. The present invention may feature a method to allow users to update property feature characteristics based upon the user's personal knowledge and information. The present invention may feature a method to allow users to evaluate changes in potential income and investment values of one or more properties according to one or more contemplated improvements or features added to the property to assist in the user's investment decision making process related to the acquisition, improvement strategy and budget, and projected income and expenses of a property.

The present invention may feature a method to estimate expenses by property characteristics and location. The present invention may feature a method to estimate taxes by taxing jurisdiction, specifically with respect to whether a property is reassessed upon improvement and/or sale. The present invention may feature a method to estimate insurance through crowdsourcing insurance cost data. The present invention may feature a method to adjust for operating payroll costs by means of relative labor costs and number of units. The present invention may feature a method of estimating utility operating costs by location and property characteristics. The present invention may feature a method of estimating repair and maintenance operating costs by property characteristics. The present invention may feature a method to estimate improvement costs associated with property and/or unit improvements.

The present invention may feature a method to estimate net operating income of a property. The present invention may feature a method to estimate market capitalization rates by location. The present invention may feature a method to estimate loan rates by property type, number of units, location, or a combination thereof. The present invention may feature a method to identify markets with the highest likelihood of finding profitable deals. The present invention may feature a method of identifying and sorting potential income property deals by profit potential and other user-selected valuation metrics. The present invention may feature a method of refining income property value calculations based upon user input. The present invention may feature a method of allowing users to inspect and modify the underlying assumptions related to the user's investment strategy, assumed current and future market conditions, and property characteristics and to enter customized assumptions. The present invention may feature a method of ranking properties by calculated investment metrics. The present invention may feature a method of identifying properties with high profit potential. The present invention may feature a method for identifying properties that are renting substantially below market rent potential. The present invention may feature a method for identifying below market rent outliers as indicators of above average investment opportunities, rather than as input into an over fitted model trained in under performing properties.

The present invention may feature a method that calculates profit potential by taking into consideration potential market rents with improvements plus estimated costs of those improvements. The present invention may feature a method of matching and connecting sellers, buyers, lenders and other real estate professionals based upon the evaluation and classification of potential deals utilizing the claims above. The present invention may feature a method of evaluating and ranking the investment potential of one or more geographic areas. The present invention may feature a method of tracking, detecting and alerting investors and real estate investors of deals that meet their criteria utilizing the claims above as new properties are listed for sale. The present invention may feature a method of graphically displaying projected future debt, equity and cashflow growth over time. The present invention may feature a method utilizing the claims above to display valuation metrics, such as profit potential, maximum suggested investment purchase offer price, etc on an interactive web-based map. The present invention may feature a method incorporating the value-add cost and value calculations, combined with a sales comparison approach to calculate and display valuation metrics, such as profit potential, maximum suggested investment purchase offer price, etc for single family homes on an interactive web-based map.

The predominant method used by income real estate investment professionals to value income properties is the income approach. This differs substantially from the sales comparison approach used to evaluate owner-occupied single-family homes. The income based approach to valuation necessarily relies on accurate rental rate predictions, as well as operating expense projections and market valuation rates, such as the “capitalization rate” or “cap rate,” that relate property net income to property value, which may be different for different types of income properties.

Rental rate prediction, along with property valuation in general, is both art and science in that both quantitative and qualitative characteristics of properties determine rental rates and property values. In particular, rental rates are in part a function of the attractiveness to renters of the features, quality, condition, fixtures, and other characteristics of the rental property. Some of these characteristics can be more easily quantified or specified with boolean values than others. Human input related to the subjective aspects of rental rate and property value predictions are critical for optimum accuracy of those predictions.

Also, not all of the relevant information may be available within a database, and therefore must be ascertained by human inspection. For example, rental rate depends in part on the quality and condition and features of the rental unit interior. If that unit has not been publicly advertised or the quality, condition and features of the interior are otherwise unknown and input values are missing from within a predictive models database, the predicted rental rate will be in error due to this lack of information. However, this missing information may be provided by a user who gains access and visibility to that rental unit. In order for that additional human-procured information to be included in the prediction of the rental rate for that unit, there must be an opportunity for the user to directly and manually input the missing information into the database and the predicted rental rate must be recalculated incorporating the new information provided by the user.

Furthermore, an investor may wish to evaluate the rental rates and resale value of a property with contemplated improvements to the property that do not currently exist. Once again, the user must then have the ability to enter new information related to the contemplated improvements, and the predictive model must recalculate the predicted rental rate and property value with the contemplated improvements incorporated in a timely and responsive manner to be of practical value to the user of the system that relies upon the predictive model for predicted rental rates and property value.

A third example of how human input can improve the accuracy of a predictive model is in the selection of comparable units upon which a rental rate prediction is based. A predictive rental rate model that relies on the rental rates of comparable rental units to predict the rental rate of a subject unit relies upon a finite set of features identified within the predictive model to determine (a) which rental units are most comparable and/or (b) the incremental values of features that exist for both the comparable rental units upon which the predictive model is based or trained and the characteristics of the subject rental unit for which a rental rate is being predicted. Errors arise in the predicted rental rate in either of these approaches when there are errors in the accounting of characteristics of the subject units or in the characteristics of the units upon which the model is based or trained, whether due to errors in human data entry or machine recognition of features. Errors also arise when there are differences between the comparable and subject rental units that are not captured within the predictive model due to features or characteristics that are beyond the set of predictive inputs used by the predictive model. In all of these cases, the accuracy of the predicted rental rates and dependent property values may be improved with human intervention. This invention provides for the human intervention necessary for more accurate rental rate and income property value predictions.

The present invention may comprise pipelines of data that are procured from a plurality of sources. The present invention may further comprise one or more predictive model databases used to hold the data used and produced by a plurality of predictive models. The present invention may further comprise computer programs that read, transform, map and write the data from their original source formats to the format utilized by the predictive model database. The present invention may further comprise computer programs that comprise the predictive models that are used to clean, analyze and transform data to determine algorithms, coefficients, and indexes related to property physical characteristics, property internet presence characteristics, unit rental rates, property revenue, property operating expenses, property net income, property debt service costs, property improvement costs, market characteristics, market and property capitalization rates, geographic characteristics, demographic and economic characteristics, etc. The present invention may further comprise one or more application server databases used to hold selected data from the predictive model database and client user data. The present invention may further comprise computer programs to transfer data between the predictive model database, and the server database. The present invention may further comprise computer programs to read and write from the application server database and the user interfaces to display property and market information in mapped, tabular, and other graphical formats, plus user workflows that allow users to enter input and to inspect, select, deselect and override specific data records and calculations used to produce intermediate and terminal calculated values required for the evaluation of income property real estate.

The invention utilizes a parametric model so that the property evaluation calculations may be performed more nimbly in real time at the software application level without necessarily having to recalibrate the entire database each time a user provides new input or deselects, selects or overrides default values. One or more individual components of the property evaluation calculations are pre-calculated and retained within the application server database, but these individual components of the overall calculations may be temporarily altered or replaced for calculations that apply to a specific property, set of properties, geographic area, or globally for the user across all markets and properties, etc. The present invention additionally features an automated method for visually identifying discrete elements of unit interiors (or exteriors), such as a stainless steel refrigerator, modern vinyl flooring or granite countertops, etc. and then using various mathematical and machine learning methods to identify the incremental contribution to value of each identified element alone and in combination with other elements, to establish an AQS value for that unit.

The inventors of this system recognize that when experienced investors use the income approach to determine the investment value of income real estate, that in addition to considering the current net income being generated by a property, experienced investors may also consider and estimate the future potential net income of a property.

This is because investors may be willing to pay more for a property that has more upside potential than a comparable property with less upside potential. In order to estimate the future potential income of a property, an investor may consider “value-add” improvements to the physical condition and operations of the property that will allow the property to generate additional rental income and/or operate at reduced operating costs. The investor may also take into consideration the expected market appreciation of rental rates and the inflation of operating expenses over time, which may be expected to be different for different properties, geographical locations, markets, and time frames. This invention utilizes a plurality of models that predicts values, rental rates and expenses of a property given its current condition and the rental rates and conditions of comparable properties. This invention also allows a user to simulate various value-add scenarios, to use the models of this invention to predict expected changes in revenue, expenses and value for one or more subject properties based upon specific contemplated improvements. In some embodiments, in addition to testing various value-add improvements to the property, this invention allows the user to simulate how various assumptions about how the market will perform and how future market performance may also impact one or more properties' revenue, expenses and values.

Investors may have specific knowledge of properties, locations and markets in which they operate. This invention allows users to incorporate their specific individual knowledge into automated valuation calculations, while still utilizing the predictive capacity of the model.

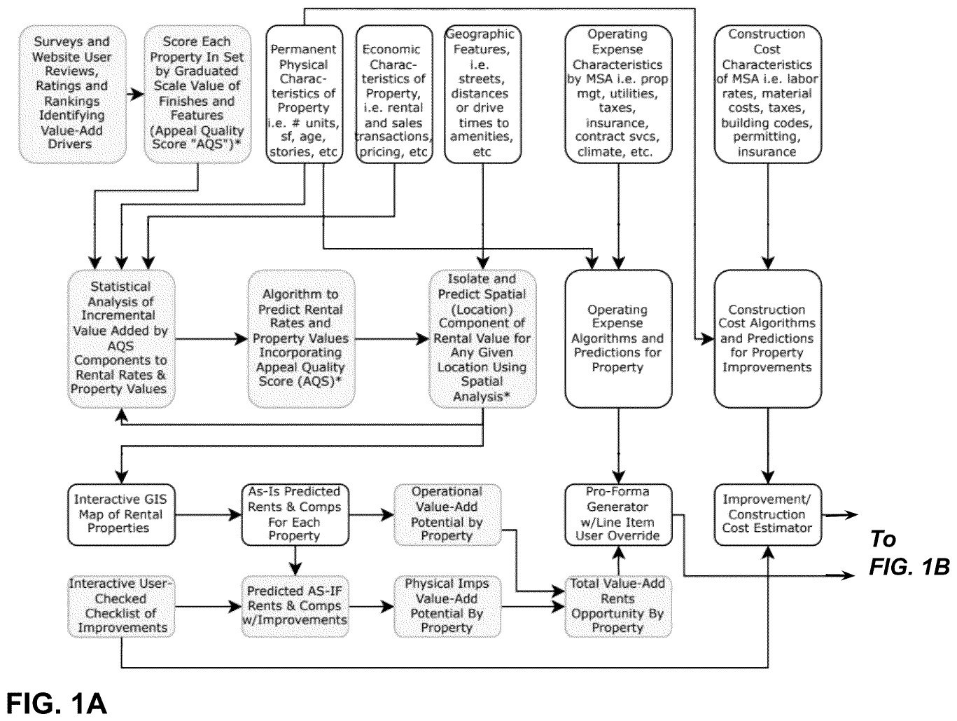

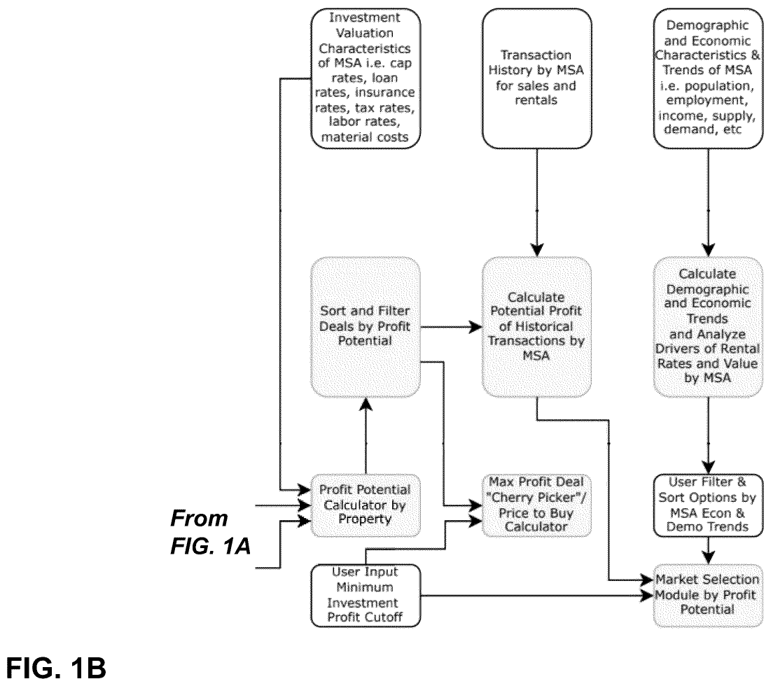

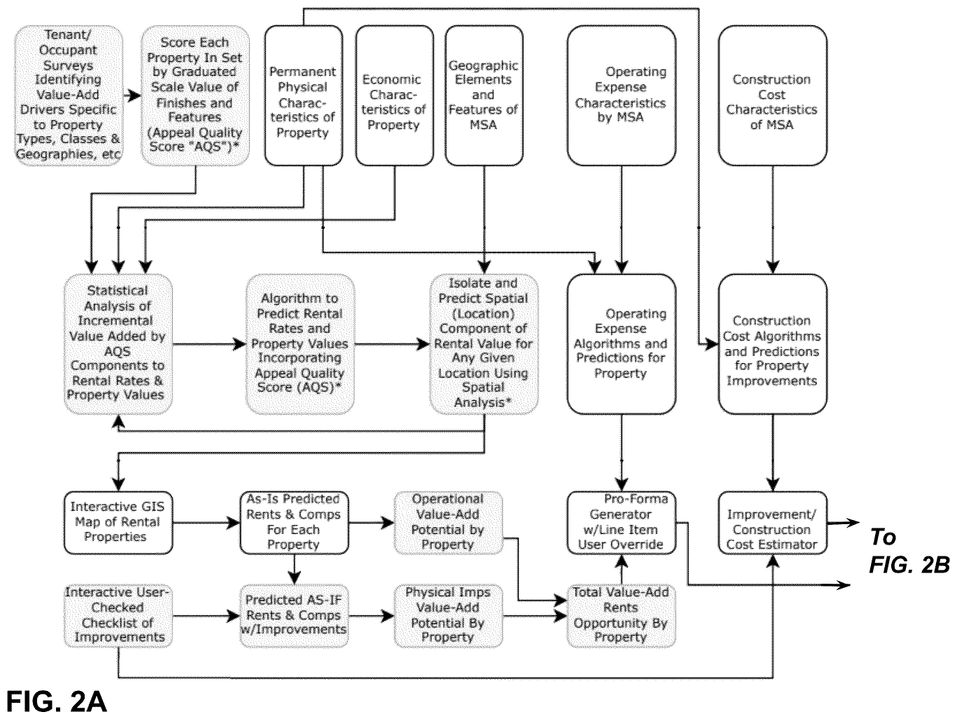

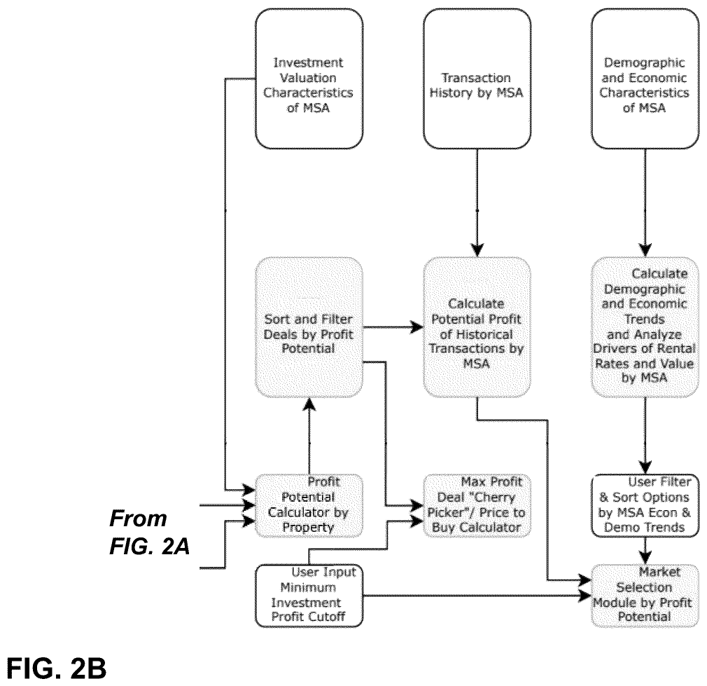

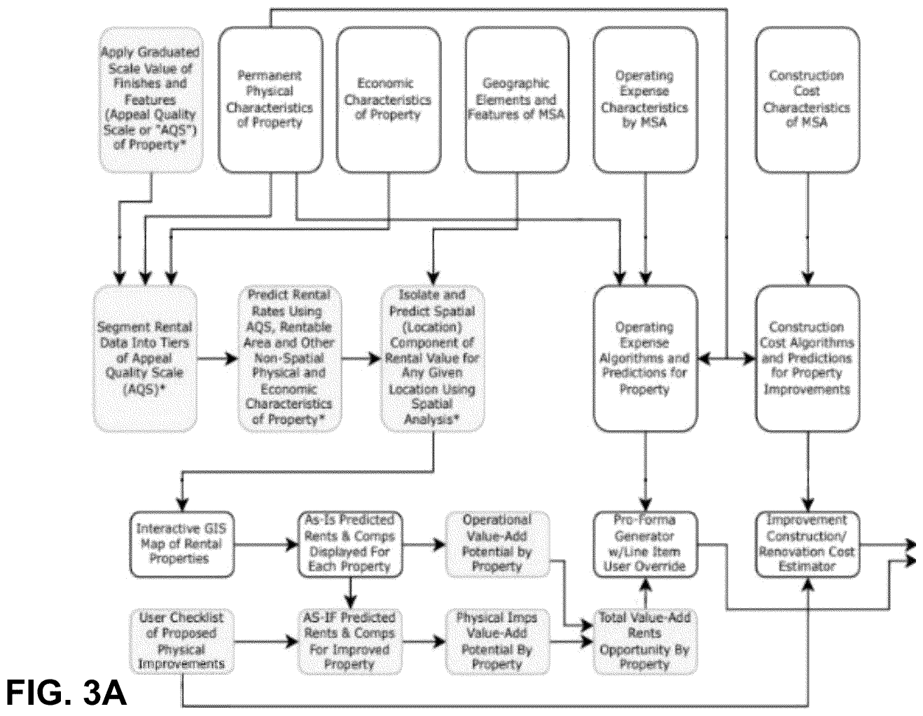

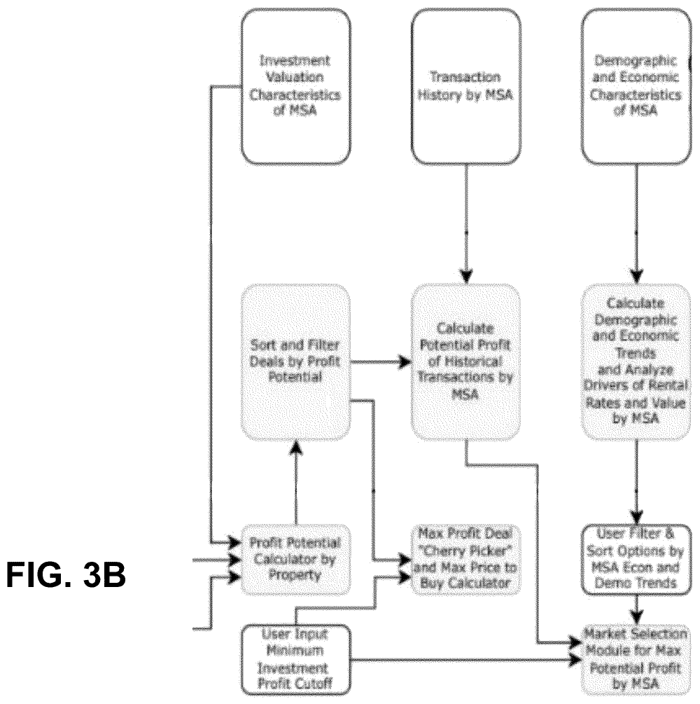

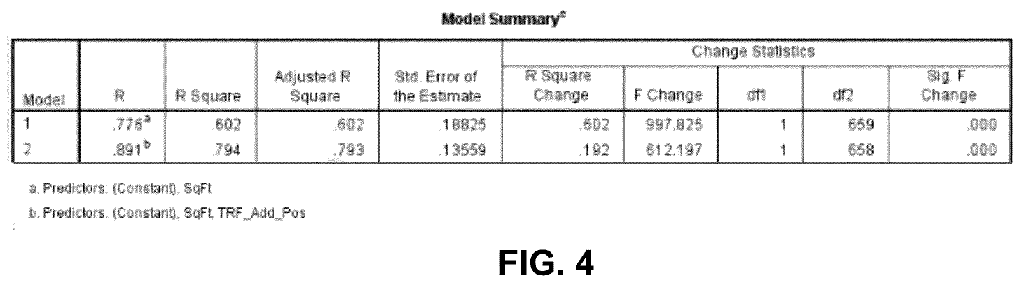

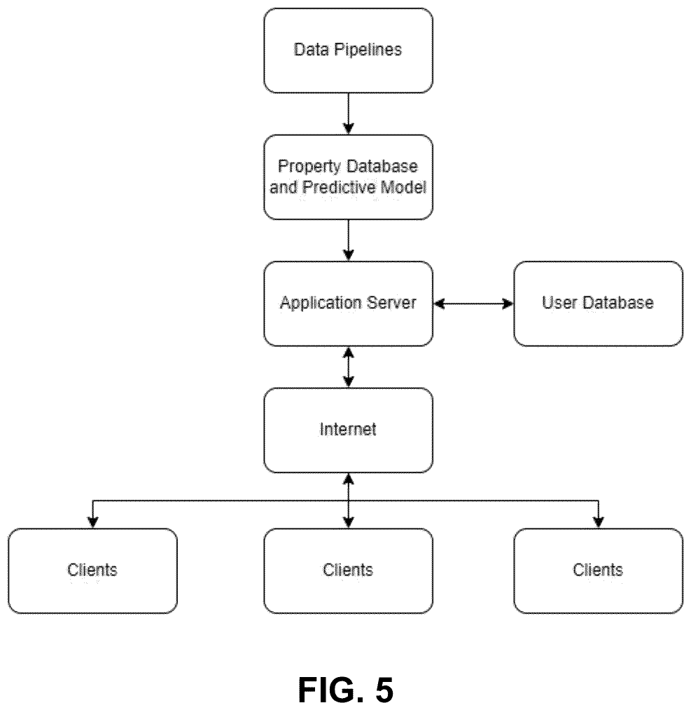

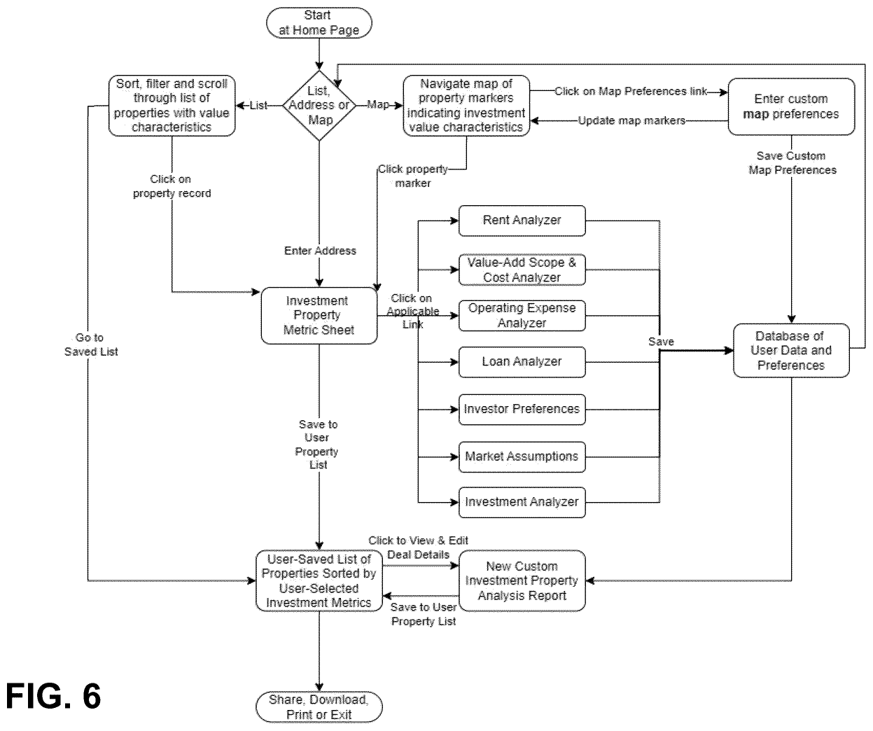

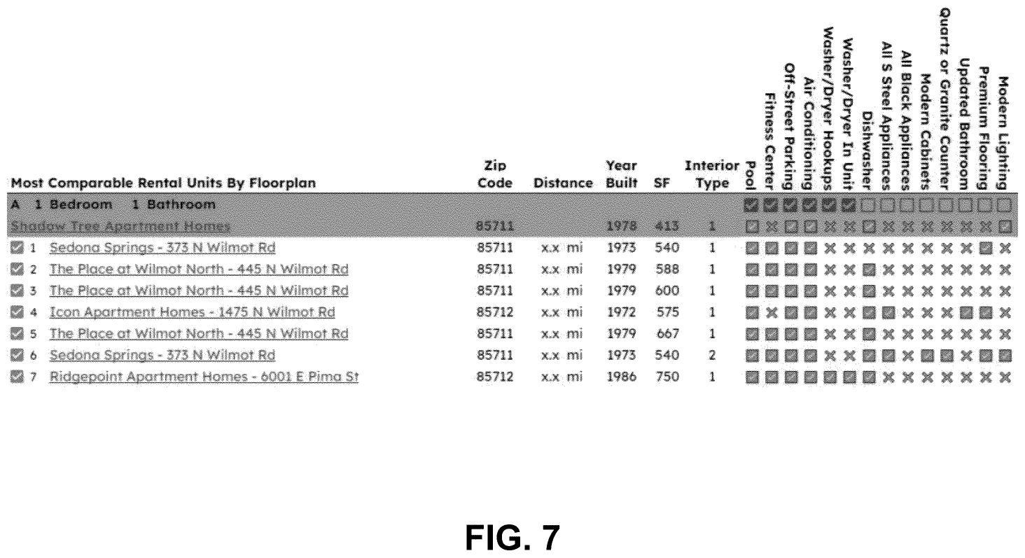

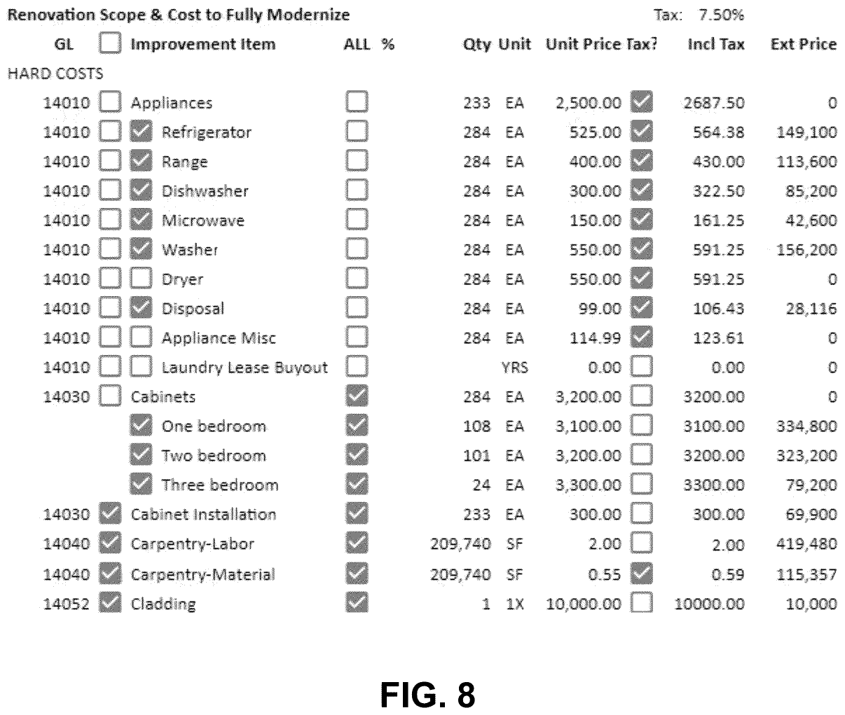

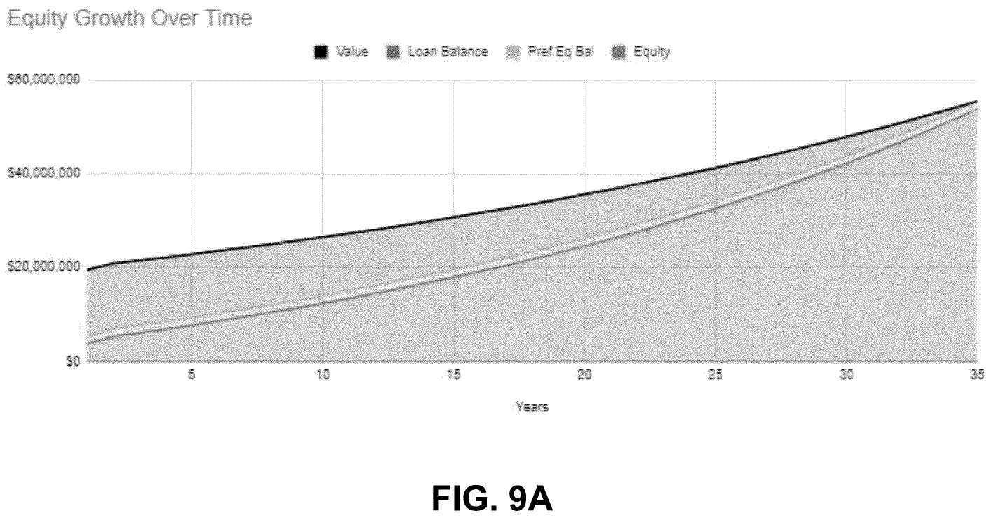

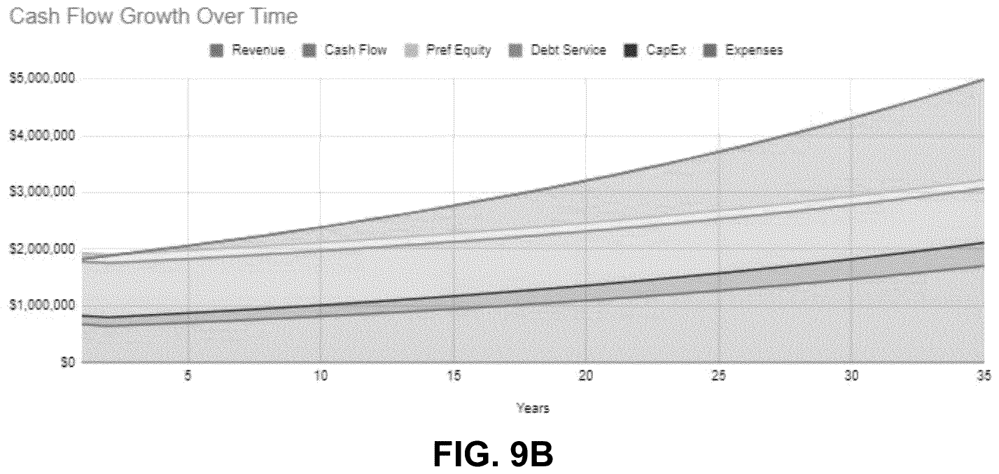

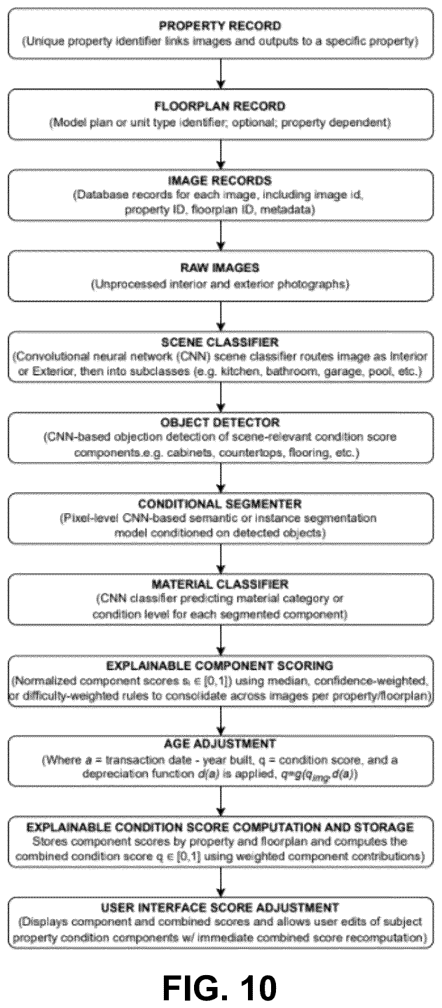

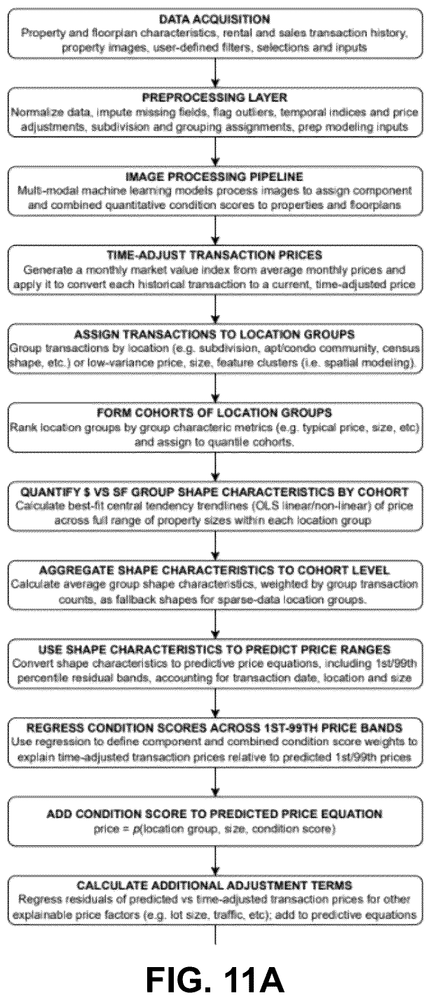

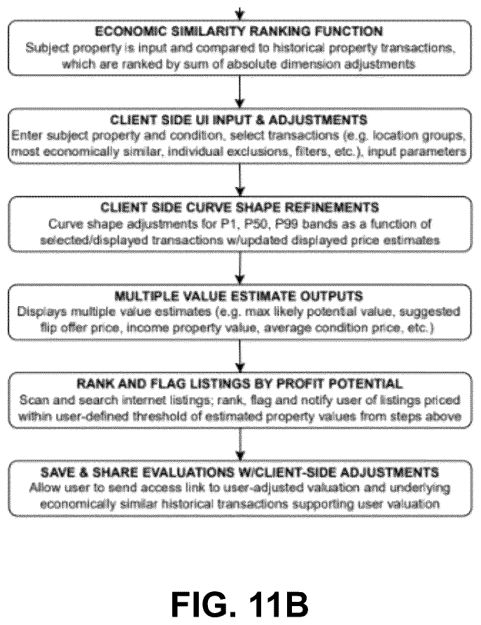

Referring now to FIG. 1, the present invention features a method for objectively and accurately estimating a value of a property, the property comprising one or more characteristics comprising one or more permanent physical characteristics, one or more economic characteristics, a geographic location, and one or more features, finishes, fixtures, and equipment (FFFEs) comprising one or more qualitative aspects. Values are estimated by inputting, comparing, modeling and relating the reported values and quantitative and qualitative characteristics and locations of other properties of a similar property type (i.e. multifamily apartments, single-family home, commercial properties, etc) to one or more subject properties for which one or more values are to be estimated. In some embodiments, the method may comprise accepting the one or more characteristics of each property and calculating an Appeal Quality Scale (AQS) value of the one or more FFFEs of all properties of a specific property type within a given geographical area for which information is available, including the subject properties for which values are to be estimated.

In some embodiments, calculating the AQS value may comprise providing a scoring system comprising a list of items, each item comprising a weight corresponding to the item's contribution to an overall appeal and quality of the property, and a set of criteria for scoring each FFFE of the one or more FFFEs based on individual appeal and quality. Each item may correspond to an FFFE of the one or more FFFE's. The overall quality and the individual quality may be determined based on data gathered from a plurality of past, current and/or prospective property owners and/or lessees. In some embodiments, the method may further comprise assigning each FFFE of the one or more FFFEs a score based on the set of criteria of the item corresponding to the FFFE, calculating, based on the score and weighting of each FFFE of the one or more FFFEs, the AQS value.

The AQS values, combined with the one or more permanent physical characteristics, and the one or more economic characteristics of properties of a similar property type within a common geographic area are collected then inputted into an AVM database. Algorithms and statistical methods, such as by regressing the AQS value against property values as part of a multivariate regression model, are used to correlate physical characteristics and AQS values to property values in the database to produce a preliminary prediction of actual and/or potential value of one or more subject properties with given permanent physical characteristics, given the subject properties' actual or potential AQS value calculated from the subject properties' actual or potential FFFEs characteristics. The actual or proposed FFFE characteristics of the subject properties may be already contained within the AVM database or entered or overridden by the AVM user. If the AVM user enters proposed changes or improvements to the FFFE characteristics, a new AQS value is calculated based upon the user's selections of proposed FFFE improvements and the property value is updated accordingly.

In some embodiments, since FFFE characteristics are inputted and resulting AQS values calculated for all properties within the AVM database, and permanent physical characteristics and economic characteristics (i.e. sale prices or advertised or actual rental rates) are also collected and inputted into the AVM database, preliminary predictions of value are calculated and stored for each property within the database. These preliminary predictions may not yet incorporate location values into the value prediction because location values are calculated separately and incorporated into a final prediction of value in subsequent steps. In some embodiments, since the preliminary predictions of value do not include location, the next step involves the calculation of the location value of each property so that the contributory value of location can be modeled and used to predict location values throughout a geographic area for existing and proposed properties and/or improvements to properties and their FFFEs.

In some embodiments, the individual differences between preliminary predictions of values and actual recorded values for individual properties and rental units within the database are plotted and used to assign actual or relative location values to the locations at which the properties exist. Thus these deviations of actual values from preliminary predicted values provide an indication of the contributing value of each location to the value of the property at each location. These location values are then combined within the AVM with the preliminary predictions of values to produce more accurate final predictions that incorporate the AQS, the location value and other characteristics of the property and its location.

In some embodiments, these location values for locations at which property information exists and is available can be used to predict location values for other areas within the same geographical area for which little or no property information exists, using spatial modeling techniques. Predicted location values for locations where no properties exist are then used to assist in calculating the values of potential properties or property improvements at those locations. In some embodiments, these calculated location values can be combined with the one or more geographic characteristics of the area surrounding the property, which can then be used to further refine the final predictions of both location values and property values.

In some embodiments, the method may further comprise incorporating data corresponding to the property to an interactive map of properties, the data comprising a location of the property, the one or more characteristics of the property, and the predicted value of the property. In some embodiments, the method may further comprise determining one or more potential added or improved FFFEs of the property, calculating a potential AQS value of the one or more potential added FFFEs, and generating a list of comparable properties and/or a pro-forma operating income statement for the property, including a potential value based on the value of the property and the potential AQS value of the one or more potential added or improved FFFEs.

In some embodiments, in providing a list of properties comparable to a subject property, as a user of the invention selects from a list of existing or potential improvements of FFFEs of a prescribed level of quality, according to the types of qualitative criteria described earlier, the list of comparable properties presented to the user changes to reflect the proposed changes in FFFEs and corresponding AQS value. A time series of rents or values may also be included, providing an indication of the direction and magnitude of changes in rent or value for one or more properties over time.

In some embodiments, after location values are taken into consideration in the final value predictions, differences between the predicted values of rents and the actual value of rents may used to identify operational value-add opportunities to bring actual rents up to predicted rents through the improvement of one or more operational characteristics, which may comprise of comprise the type and quality of property management, maintenance offered resident services; communication quality and channels between residents and property management, pricing strategy and composition of charges for rent, utilities, amenities common area maintenance and other charges and fees; promotions, retention programs, concessions, resident rewards programs, or a combination thereof; and any other non-physical aspect of services, charges and methods of relating to owners or tenants.

In some embodiments, the physical value add improvements may be identified comparing property values or rents at a an existing level of FFFEs and corresponding AQS score to an improved level of FFFEs and corresponding AQS score, and using the differences in values or rents to quantify the physical value-add opportunities of the property.

In some embodiments, the method may further comprise calculating, based on the one or more potential added or improved FFFEs, a predicted construction cost for implementing the one or more potential added or improved FFFEs, and applying the predicted construction cost to calculate the potential profit according to the new and improved potential value. In some embodiments, the one or more characteristics may further comprise one or more operating expense characteristics of the area surrounding the property. In some embodiments, the method may further comprise calculating, based on the one or more operating expense characteristics of the area surrounding the property, a predicted operational cost for maintaining the property. The predicted future operating income and costs of the property based upon the physical improvements may then be used to calculate and produce a future pro-forma, net operating income, valuation and profit potential of the property upon improvement.

In some embodiments, the one or more characteristics may further comprise one or more investment valuation characteristics, such as cap rate, loan rates, insurance rates, tax rates, labor rates, material costs, etc of the area surrounding the property. In some embodiments, the method may further comprise determining a profit potential value based on the one or more investment valuation characteristics of the area surrounding the property, and the value of the property. In some embodiments, the one or more characteristics may further comprise one or more real-estate transactions in the area surrounding the property.

In some embodiments, the method may further comprise providing the AVM user with the function feature of being able to compare, filter and sort the predicted profit potential value of those properties. This would guide an investor in their acquisition efforts by allowing the investor to focus more resources on evaluating those properties most likely to produce the highest profit margins.

In some embodiments, the profit potential as calculated by the methods of this invention are applied to past transactions of a given geographical region and compared to those of other geographical regions to identify the regions most likely to yield higher-margin deals worthy of investment. In this way, using this type of “back testing,” which is based upon the valuation model, based on the location values, based on the AQS calculations, the investor is guided to be able to focus on the markets most likely to produce deals with the highest profit margins.

In some embodiments, the one or more characteristics of a geographic area may be characterized by one or more demographic characteristics of the area and one or more economic characteristics of the area. In some embodiments, the method may further comprise calculating, based on the one or more demographic characteristics of the area and the one or more economic characteristics of the area, a combination of demographic and economic trends that are likely to impact property values. By combining this combination of demographic and economic trends with the unique “back testing” approach described above, an investor may be further guided in selecting markets most likely to yield the highest volume of high-margin profitable deals. In some embodiments, the properties being evaluated may comprise a single family house, multifamily apartments, commercial properties, or any other real property type and the value of the property may comprise a sale value or a rental rate.

In some embodiments, the present invention features a method for grading qualitative aspects of individual features, finishes, fixtures, and equipment (FFFEs) of a property to generate a single combined numerical value of the qualitative aspects to determine a value of the property, the property comprising one or more characteristics comprising one or more permanent physical characteristics, one or more economic characteristics, one or more location values, one or more geographic characteristics of an area surrounding the property, and one or more features, finishes, fixtures, and equipment (FFFEs) comprising one or more qualitative aspects. In some embodiments, the method may comprise accepting the one or more characteristics of the property, calculating an Appeal Quality Scale (AQS) value of the one or more FFFEs.

In some embodiments, calculating the AQS value may comprise providing a scoring system comprising a list of items, each item comprising a weight corresponding to the item's contribution to an overall quality of the property, and a set of criteria for scoring each FFFE of the one or more FFFEs based on individual quality. Each item may correspond to an FFFE of the one or more FFFEs. The overall quality and the individual quality may be determined based on data gathered from a plurality of current, past, and prospective property consumers. Calculating the AQS value may further comprise assigning each FFFE of the one or more FFFEs a score based on the set of criteria of the item corresponding to the FFFE, and calculating, based on the score of each FFFE of the one or more FFFEs, the AQS value.

The method may further comprise repeating the previous two steps for a plurality of properties within a database to calculate a plurality of AQS training values, each AQS training value of the plurality of AQS training values corresponding to a property of the plurality of properties. Each property of the plurality of properties may comprise a known value, a property type, and a geographical location. The method may further comprise categorizing each property of the plurality of properties into a plurality of property groups based on the property type and the geographical location of each property, calculating, for each property group of the plurality of property groups, a mathematical relationship between the plurality of AQS training values and the known values for each property of the plurality of properties corresponding with each AQS training value, using the mathematical relationship to generate an AQS-value prediction algorithm configured to provide preliminary predictions of value based on AQS, applying the AQS-value prediction algorithm to the property to generate a predicted value, and generating, based on the predicted value, the one or more permanent physical characteristics, the one or more economic characteristics, the one or more location values, and the one or more geographic characteristics of an area surrounding the property, the value of the property.

In some embodiments, the method may further comprise using the AQS-value prediction algorithm to assist in calculating predicted location values for the plurality of properties by calculating a difference between the known values of the plurality of properties and a plurality of predicted values generated by the AQS-value prediction algorithm, and using the difference to calculate and assign real location values to the geographical locations of the plurality of properties. The differences may be used as the location values directly or may be incorporated into an algorithm for calculating location values.

In some embodiments, the method may further comprise extrapolating the location values to calculate predicted location values for properties lacking a defined value by using one or more of spatial analysis techniques, the location values, and other geographic information. In some embodiments, the method may further comprise using the AQS-value prediction algorithm in conjunction with the one or more characteristics to qualify and identify one or more comparable properties, and electronically presenting to a user a list of the one or more comparable properties, each comparable property of the list of the one or more comparable properties comprising a current value, a potential value, a time series of historical values, one or more comparable characteristics, and one or more comparable FFFEs.

In some embodiments, the method may further comprise searching one or more public listing and leasing sites for periodic real-time updates of the known values of the plurality of properties. In some embodiments, the method may further comprise incorporating data corresponding to the property to an interactive map of properties, such as in a geographical information system user interface, the data comprising a location of the property, the one or more characteristics of the property, and the adjusted value of the property. In some embodiments, the method may further comprise using one or more interactive online input forms to submit the one or more characteristics, the one or more interactive online input forms comprising a structured questionnaire. The one or more interactive online input forms may be incorporated into the interactive map of properties to rate the one or more characteristics of the property for advertising, leasing, filtering, searching, finding, comparing, selling, or buying one or more properties comparable to the property.

In some embodiments, the method may further comprise determining one or more potential FFFEs of the property, calculating a new potential AQS value including the one or more potential FFFEs, generating a new pro-forma value for the property based on a re-calculated AQS value of the property including the one or more potential FFFEs, and presenting one or more quantified potential physical value-add opportunities achievable through implementing the one or more potential FFFEs. In some embodiments, a difference between a final predicted value, based upon the AQS value, and an actual value is calculated to indicate quantified potential operational value-add opportunities for the property. Implementing the quantified potential operational value-add opportunities may be used to maximize an income of the property.

It should be noted that a unique and valuable feature of this system is that location values can be more accurately calculated because of the unique process associated with the system of assigning AQS scores to each property so that location values can be more accurately modeled by comparing properties of similar AQS scores, rather than by comparing properties across all AQS values at once. This system is also unique in that it recognizes in its calculations the synergistic value of having multiple FFFEs present at the same time, which often exceeds the sum of the additional incremental values associated with individual FFFEs. For example, a unit that has all modern and updated FFFEs, but it still contains the original cabinets, may receive an outside boost in potential value if the cabinets were replaced to match and make the rental unit congruent with the remainder of the updated FFFEs.

In some embodiments, the method of the present invention may be encompassed by a computing system in the form of a software application. In some embodiments, the software application may comprise a user interface for accepting the characteristics, the FFFEs, and the potential added FFFEs as input from a user. In some embodiments, the application may accept a partial input from the user and may fill in the blanks by searching a database of locations and property value data (e.g. generating geographic characteristics based on an address). In some embodiments, the application may return the property value as an output. The property value generated by the method of the present invention may be added to a public and searchable database along with all other imputed and available data corresponding to the property. The public database may have sorting and filtering functions in order to only display certain properties based on one or more parameters (i.e. price, location, etc).

The AQS is comprised of one or more individual components that are individually graded on a graduated scale or in a binary or multiple choice fashion using checklists, graduated scales, numerical grades, rubrics, multi-dimensional matrices, and any other method that assists in converting qualitative characteristics into numerical values that may be consolidated and incorporated into mathematical models using regression, classification and other statistical analysis techniques. Of particular importance from a statistical modeling perspective for older real property resale values and rental rates, the AQS accurately gauges the degree to which an older property has been or can be updated or renovated as it relates to the attributes most important to the buyer or tenant and the incremental increase in value created by those improvements and updates. The AQS may be applied to residential, commercial and other property types. The AQS may be applied to existing and potential improvements in predicting property values and rental rates. This is valuable in that it may aid potential investors to gauge the investment value of making specific improvements to the property by comparing the cost of the improvements to the incremental increase in value of the improvements. The AQS may include and incorporate both quantitative and qualitative characteristics. The AQS may be normalized over a scale from 0.0 to 1.0.

The basis for the list of components comprising the AQS, the grading scales and the relative weighting of the components may include the judgment of subject matter experts within a relevant field of expertise; surveys of prospective or current buyers or lessees of the specific property type being modeled; or ratings, rankings and reviews of properties and rental units input by users of an interactive website interface integrated as part of an embodiment of the invention described herein. Input collected from buyers or lessees via surveys or website interfaces may include rankings, ratings, value estimates, Likert scales, and open-ended questions reflecting the importance to them of qualitative and quantitative aspects of the specific type of property they occupy. This input may be used to create or update the list of potential components for the AQS of a given property type.

The components that comprise the AQS for a property will vary by property type. This is because the relevant qualitative aspects of different property types that appeal most and carry the most value for different users of each property type will vary. For example, while lessees of a multifamily rental property might value modern, full-size, glass-front in-unit washers and dryers and smart technology thermostats, prospective buyers of a single-family owner-occupied property might value a new roof and new air conditioning system and a retail store tenant might value a large, visible storefront and easy access to their parking lot. The entire panel of qualitative elements that comprise the AQS, and the weighting of each element to arrive at a single AQS score for the property, must vary by property type. The weighting of each component may be determined or refined through statistical analysis of the potential components and their individual and combinatorial effect on property values and rental rates, the results of machine learning techniques trained on data sets, and other related methods for including, excluding and weighting the components of the AQS.

The grading process to establish an AQS score for each property or rental unit within a geographical data set will typically include the review and analysis of individual images of each property or rental unit within the data set, combined with other publicly available or privately obtained data related to each property or rental unit. The review and analysis of images and grading may be performed manually by humans or by artificial intelligence/machine learning trained on data sets previously graded by humans or other means. Once all properties or rental units of a certain type, size and class within an MSA, city or other geographical region have been graded, the AQS and/or its individual components, or various groupings or sub-groupings thereof may be added as independent variables in an automated or non-automated valuation model or rental rate prediction model.

These prediction models incorporating the AQS to improve accuracy may include any combination of the following or other predictive modeling methods: simple linear regression, multiple linear regression/multivariate regression, logistic regression, nonlinear regression, decision trees, random forests, support vector machines, neural networks, time series analysis, Markov Chain Monte Carlo Methods, Hidden Markov Methods, stochastic Differential Equations, Gaussian Processes, Stochastic Volatility Models, various applications of bayesian and stochastic methods, and as discussed below spatial analytics methods including, but not limited to exploratory spatial data analysis, overlay analysis, spatial clustering, geographically weighted regression, spatial econometrics, spatial interpolation, geostatistical analysis, kriging, variograms and covariograms, spatial autocorrelation, etc.

The AQS may be used as input into a value or rent prediction model as one or more independent variables in whole or as one or more of its individual or combined components to more accurately predict property values or rental rates. The AQS may be used to predict property values either directly using actual or adjusted sale transaction prices to predict market values of subject properties or by using the AQS to better predict rental rates, which in turn may be used to better predict the value of income properties using an income method of valuation by more accurately predicting the income from the predicted rental rates. The AQS may be used to predict potential property values and potential rental rates based upon qualitative characteristics that exist, combined with quantitative and qualitative characteristics that do not currently exist, but could be made to exist with improvements to the property.

The AQS may be used to better predict the value of raw land, tear-down opportunities, and development/redevelopment opportunities by incorporating the qualitative and quantitative characteristics of proposed new construction projects. The AQS may be used to more accurately predict property values and rental rates by classifying properties within specific quintiles or tiers of AQS values. Once properties are classified by tiers or quintiles of AQS values, regression may be applied to more accurately determine the correlation of other non-AQS independent variables to property values and rental rates. In other words, by first eliminating the statistical noise resulting from pooling properties of all different AQS values together and then trying to correlate other independent variables to property values and rental rates, more accurate regression results may be obtained by first segmenting properties of similar AQS values and then further segmenting properties by similar size and location, etc. and then performing regression with other independent variables. This process allows like properties to truly be compared to like properties, apples to apples, with regard to both quantitative and qualitative characteristics.

In addition or as an alternative to using the AQS to classify properties by AQS values to improve property value and rental rate predictions, AQS values, or the values of its constituent components, may be used as direct input into statistical models using multivariate regression, classification, and other statistical techniques alongside other correlated or uncorrelated independent variables to produce superior model predictions of property values and rental rates.

The AQS in whole or as one or more of its components may also be used to more accurately and precisely discover and characterize the relationships of other correlated or uncorrelated independent variables related to the prediction of property values and rental rates. One of the major challenges of modeling, estimating and predicting property values and rental rates is the quantification of the impact of location on property values and rental rates. The estimation of location values, or the degree to which a specific location adds to or subtracts from the value or rental rate of a property or rental unit at that location, typically requires spatial analysis. The accuracy of spatial analysis is necessarily dependent upon the comparison of non-spatially comparable properties or rental units across different locations. In other words, knowing that highly updated properties can achieve values and rental rates as much as twice as much or more than their otherwise identical non-updated counterparts, effective spatial analysis, especially on data sets that include older properties, will not be possible if both updated and non-updated, or minimally updated and maximally updated, properties are being fed into a spatial analysis model as equals.

Therefore, combining the AQS with spatial analysis techniques will produce more accurate prediction models than either could provide individually without the other, and will also enable location values themselves to be more accurately predicted. Since location value is sometimes assumed to be the remainder error in a multivariate regression type of approach to predicting property values and rental rates, it is imperative that the bulk of the other primary non-spatial independent variables be adequately accounted for, including the qualitative characteristics that are typically excluded from the auto valuation and rent prediction models. An example of this is given in the embodiment described below. Additional accuracy gains can be made by combining the AQS with kriging and cokriging using census block boundary shape files and secondary characteristics associated with each census block. Census blocks may be uniquely appropriate as geographic areas for rental rate and property value prediction models because of their high correlation with urban and natural features across which location values may change abruptly or gradually and because census block shape files are readily available across the entire US from the Census Bureau. The AQS may be applied within one or more steps within a multi-step statistical modeling process so that polynomial or other types of mathematical algorithms or curves relating property value or rental rates to AQS values are determined during one or more of those steps.

Below is a simplified example of this process being applied to the prediction of rental rates throughout an MSA, for illustration purposes only, which may be applied in a more streamlined process using standard statistical modeling and machine learning techniques, which could include many more independent variables and classification and regression processes. In some embodiments, the method may comprise plotting all or a portion of the rental units within an MSA or other geographical region as a rental rate vs square foot scatter plot, or rental rate squared vs square foot of rentable living area scatter plot, with all of the different sized rental units within a single property each representing a separate series of data, and then calculating the best fitting nonlinear regression curves to each series representing a unique property of uniform AQS values among all rentable unit sizes at that property. The result is one curve plotted for each property within the MSA.

The method may further comprise finding the average curve or best fitting algorithm representing the average of all the curves plotted above, finding the square footage at representative quintiles, such as at the 25th, 50th, and 75th percentiles, of all rental units within the MSA, calculating the predicted rental rate for each property in the MSA at each of the 25th, 50th, and 75th percentiles of square feet using the rental rate vs square feet curves for each property plotted or calculated above, and, for each property, plotting points on a scatter plot of the rental rate at the 50th percentile of square feet vs AQS. This repeated for separate plots for rental rates at the 25th and 75th percentiles of square feet vs AQS as well.

The method may further comprise finding the best-fitting nonlinear regression curve or algorithm that relates AQS to the rental rate at each of the three fixed square footage values, combining the nonlinear regression curves relating the independent variables of square feet and AQS to the dependent variable of rental rate into a single algorithm, using the combined algorithm above to predict the rental rates for all or a portion of all of the rental units within the MSA, and subtracting and storing the actual rental rates minus the predicted rental rates for each rental unit. (This may be called the location remainder or difference after regressing for square footage and location above).

The method may further comprise spatially plotting the differences calculated above within a GIS application according to each rental unit's known x-y coordinates, using spatial analysis, such as geostatistical methods, including kriging, and using a geographical 2- or more dimensional mesh, such as census block shapes, to predict location values of each geographical area, such as each census block, for all blocks, including those with and without data points, with the assistance of co-kriging secondary characteristics related to census blocks, or other geographical areas being used, to assist in the prediction of location values. Secondary characteristics of census blocks that may be used for co-kriging, would include among others: tenure (home ownership vs renting) rates, household income, proximity to jobs, proximity to grocery stores, classified by user reviews or ratings, demographics, traffic, as measured by automobile traffic, cell phone location tracking, etc., proximity to jobs, classified by income levels, etc.

The method may further comprise Incorporating the square footage, AQS, and location values and algorithms into a single model utilizing one or more algorithms to predict rental rates of real or theoretical rental units at any location and of any size and AQS value throughout the MSA, testing for accuracy, and iterating the steps above, as with machine learning techniques, to refine the model and algorithms and improve the prediction accuracy of the model.

The systematic inclusion of qualitative characteristics in the form of the AQS in a property value or rents prediction model can produce significantly more accurate property value and rent predictions and can then be applied in the following ways as an example of one combination of embodiments of this invention to create a powerful Acquisition Guidance System (AGS) that guides users to quickly identify properties with the greatest value-addition or profit potential. The method may comprise providing owners, buyers, sellers, lenders, insurers, landlords, tenants, property managers, contractors, developers, appraisers, tax assessors, and others with property value and rental rate estimates for existing or potential properties or rental units, with existing or potential quantitative and qualitative FFFEs.

The method may further comprise providing output in tabular, graphical or geographical form, on-demand via a web portal, website, geographical information system (GIS) interface, or other user interfaces. In some embodiments, this may allow users to assess potential transactions with more accurate information related to the inclusion of qualitative aspects of properties as provided by the incorporation of the AQS. A web interface may provide for interactive user input on the qualitative aspects of properties with which the user has a direct familiarity that correlates with the AQS components for that property.

User input may be aggregated and analyzed in conjunction with input from other users as input into the components or calculation of the AQS for that property type or classification. In addition, the reviews, rankings, and scores of qualitative FFFEs for that property may be provided individually or in aggregate, as output to users of the website reviewing a property for potential purchase or lease for them to consider in their decision-making. This differs from typical rental leasing or property-for-sale websites, which generally only provide one overall review and/or rating per property. Since we know that the qualitative characteristics of a property significantly impacts the value of that property, we may also assume that having online access to the qualitative information about properties in advance of driving out to see the properties in person may be important to potential buyers or lessees prior to choosing which properties they wish to consider for further evaluation.

The method may include an owner intake sheet prompting the owner/lessor or property manager of a property to complete a pre-established online form regarding quantitative and qualitative information of the owner's/lessor's property, upon which the calculation of the AQS for that property may be at least partially based. The method may further provide for online forms for prospective or actual buyers and tenants to rate one or more of the items included on the owner's/lessor's online intake form, upon which the calculation of the AQS for that property may be at least partially based.

The information from both the owner's/lessor's intake form and the buyer's/tenant's rating form may be presented on an interactive online geographic information system interface whereby the information is presented to the public or to private subscribers of an online platform. The information may be presented in part or in full, individually or in aggregate, raw or further processed through additional calculations, and may be used to provide listing, leasing or advertising services for to the property being sold or leased for the benefit of the owner/lessor and to give greater, more granular information about the property to the prospective buyer/tenant.

The method may further comprise a feature whereby prospective tenants or buyers may create a folder or portfolio of properties they are reviewing as a subset of the properties in the database, and check off or rate features associated with each of the properties they are reviewing, and then compare them against one another, feature by feature, at any time. Users may also write in additional components of their own to be checked off or rated for each property. All of the results of these ratings and check boxes and new components may be incorporated into future AQS calculations of the AVM.

The method may further comprise identifying and providing information related to comparable properties or rental units that are truly comparable to the subject property to support the underwriting of property values and rental rates in that in addition to sharing similar quantitative and geographical features, the comparable properties selected also share similar qualitative characteristics as measured by the AQS, and identifying and quantifying “value-add” real estate investment opportunities by predicting the likely increases in property values and/or rental rates associated with corresponding proposed qualitative and quantitative improvements and updating to an existing property. With more accurate predictions of rental rates, rental income-related value-add opportunities could be further broken down and quantified into physical value-add opportunities and operational value-add opportunities.

Physical value-add opportunities would typically include improvements to or replacement of valuable exterior or interior property FFFE and could be calculated based on the estimated incremental increase in physical updating and improvements as reflected by the change in AQS value by calculating the difference in rents between the as-is AQS value and proposed improved “as-if” AQS value.

Operational value-add opportunities, which would typically include such things as quality of property management, maintenance, customer service, resident services offered, communication quality and channels between residents and property management, pricing strategy, promotions and retention programs, concessions, resident rewards programs, etc. could be calculated as the difference between the predicted market rental rate based upon rental rates of comparable rental properties and actual rental rate of rental units at the subject property without improving the subject property's AQS value.

Physical and operational value-add opportunities could be summed to calculate the total value-add opportunities and could be calculated for both the potential rental rate value-add opportunity and the potential property value-add opportunity. Interactive user selection of potential improvements via a checklist, slider or other input mechanisms would allow users to customize the degree of proposed renovation or updating and display the corresponding increase in rental rates or property values for a given property or rental unit. In this way, users may interactively use this site to adjust and calculate the value-add opportunities associated with various levels of improvements, renovations, or updates.

The method may further comprise identifying and quantifying real estate investment opportunities related to new construction, land development, tear-down and redevelopment, or additions to existing developments. Users may select locations of raw land or land with existing uses and specify the quantity and quality of proposed improvements at that location using an interactive improvements selection panel that would predict the rental rates and property value for the property with the as-if improvements taken into consideration.

The method may further comprise combining the automated rental rate projections for rental units described above with the physical property characteristics of whole properties and expense projections for each property to produce automated net operating income and valuation projections for income properties. These value-add potential calculations may be combined with projected future market and economic changes over time, such as the measurements of current and projected supply and demand of similar properties within the geographical market, projected cap rate and borrowing interest rate changes, projected population and employment growth, etc to provide a robust calculation of projected investment returns for any given property in an automated fashion.

The method may further comprise adding construction cost estimates for updating or improvements based upon user-selected potential improvements, including the qualitative aspects comprising the AQS, a potential profit may also be calculated for each property by subtracting the sum of the costs associated with acquiring the property in as-is condition and holding and improving the property from the calculated value of the property following the completion of selected as-if improvement fewer costs of sale.

By combining the applications above, a complete Acquisition Guidance System (AGS) may be produced, whereby properties across vast geographic areas, such as the US or the world can be mapped and labeled with the value-add and/or profit potential associated with each property. Presenting these results in tabular or graphical form, such as in a GIS web application, combined with an interface function feature that allows the user to sort and filter properties by value-add or profit potential, would allow users to quickly and easily identify the properties with the greatest value-add and profit potentials on which to spend additional resources to investigate and evaluate for consideration or acquisition.

Detailed pro-forma reports may be provided to users upon demand specifying the income and expenses calculated and estimated above, which could be interactively overwritten on a line item basis by users as they investigate and gain more intimate knowledge and familiarity with the property being investigated during their due diligence. Similarly, other financial reports, which necessarily depend upon the accurate estimation of value or rental rates of a property being considered for improvement, including those related to the qualitative aspects of the property, may be automatically generated and made available to the user.

A market selection module may also be created by comparing historical real estate transaction prices for corresponding properties within one or more markets and applying the estimated profit calculations described above to each transaction. Aggregating the results across the markets allows the user to test which markets are most likely to yield the greatest number, volume or magnitude of profitable transactions and therefore warrant the most attention as part of a real estate acquisition or evaluation program.

In some embodiments, the database for importing, storing, and retrieving AQS data may be generated by a method comprising importing existing property data from external data sources regarding property type, rentable or livable area for each livable unit type, location and other physical property characteristics, ranking each property in MSA by an “Appeal Quality Scale” based upon discrete FFFEs, and conducting and compiling results of surveys among tenants or buyers from representative sample properties that rank FFFEs in order of perceived value and include write-in options to add desired FFFEs not listed in the survey.

The method may further comprise creating a checklist of the most influential FFFEs identified above that differentiate lower-appeal/lower-value properties from higher-appeal/higher-value properties, particularly including qualitative interior FFFEs not necessarily explicitly listed as fields in listing databases such as MLS sites or Zillow, and also not included in existing automated rental rate or property value prediction algorithms.

The method may further comprise completing the checklist, optionally presented as a data entry interface within the database, created for each relevant property/rentable unit type within the database for which information is available, such as from pictures on websites where properties are listed by owners or agents for rent or sale, checking the boxes for the items on the checklist for each FFFEs that exists for that property and leaving the boxes unchecked for each FFFEs that does not exist for that property. Methods for completing the checklist may comprise a manual review of photos and listed FFFEs, scraped data, and/or applying optical recognition, machine learning, or other means of automated recognition of FFFEs.

The method may further comprise assigning relative weight values for each of the FFFEs as they are believed to influence rental rates or property values, creating a scale (Appeal Quality Scale or AQS), optionally normalized to a value of between 0 and 1, and using the checklist results for each property and the weights assigned above for each FFFEs on the checklist, to automatically calculate and assign AQS values for each property, with 0 indicating that the property does not have any of the highly valued FFFEs and 1 indicating the property contains all of the highly valued FFFEs and intermediate values indicating that some, but not all of the desirable FFFEs exist for that property.

The method may further comprise collecting and adding to the database listed and/or transacted rental rates or property sale prices for each property, importing relevant geographic elements of MSA into the database, and importing geographic information system elements from external data sources into the database. The method may further comprise dividing MSA into indexed city blocks (polygons surrounded and separated by streets and other similar physical boundaries, i.e. rivers, railroads, highways, undeveloped tracts of land, etc). The method may further comprise importing or calculating secondary geographic characteristics and statistics at the city block level related to demographics, crime rates, drive times and distances to neighborhood amenities, local school ratings, and economic characteristics.

The method may further comprise calculating/developing algorithms to predict rental rates or property values utilizing AQS. The use of AQS in conjunction with other inputs such as rentable/livable area, property age, and location is a critical innovation in the prediction of rental rates and property values because rental rates and property values for properties of identically sized, aged, and located properties can fluctuate by up to 100% simply due to the presence or absence of the FFFEs reflected by the AQS, a FFFEs not typically accounted for in automated valuation methods. In other words, the same property that is left unrenovated will typically rent or sell for up to twice as much once renovated. The AQS captures this difference. Automated valuation methods that do not capture this difference will not be able to achieve the level of accuracy of an automated valuation method that includes the distinction made possible by the AQS, particularly for older properties that could either be outdated or completely updated or anywhere in between.

The method may further comprise assigning quantiles to city blocks related to average rental rates or property values for each city block, using multilinear regression and other statistical techniques to refine the weighting of FFFEs based upon their empirically correlated influence on rental rates or sale prices across the entire MSA as well as across individual and comparable city-blocks within the same quantiles of average rental rates or property values (typically on a per square foot, or per square foot squared basis), creating algorithms based upon the above to predict rental rates and property values for any given property within the MSA or submarkets of the MSA, and using the rental rate/value prediction algorithms incorporating AQS to predict and assign adjusted rates/values to all properties as if all properties are of equal AQS.

The method may further comprise using city-block polygons that include both higher value properties and lower value properties, within the subject MSA, as well as across all MSAs, and applying statistical, spatial analysis (geostatistical), computing, and machine learning methods to refine the calculation of the weighting of each FFFEs in the AQS calculation, resulting in the calculated empirical mathematical impact of the AQS value of a given property on the rental or resale value of the property. Depending upon the distribution/sparsity/density of data within a given MSA, these methods may include one or more of the following techniques: segmenting and analyzing the data above separately within tiers or quantiles of AQS values or converting/adjusting all actual rental rates or property values across the MSA to AS-IF adjusted values at a single common AQS value to neutralize the AQS influence and isolate the location influence.

The method may further comprise predicting a precise impact of property location by segmenting or normalizing data based upon common AQS values as input into statistical/geostatistical spatial models. While incorporating AQS into an automated valuation model substantially increases the accuracy of a rental rate/property value prediction model for a given market (MSA) or submarket, it also creates the unique opportunity to provide cleaner, more accurate input into a spatial analysis (geostatistical) model to predict the location component of rental/property values that could not otherwise be achieved if low- and high-appeal quality properties are used as input into a spatial analytics model without regard to the quality of the properties being input into the model. In other words, when the low- and high-quality properties are being fed into a spatial analytics model without differentiation or discernment as apples and oranges, the output of such a model cannot be any more granular or accurate than the input. An automated valuation model that does not use a method such as the AQS to control for the influence of the appeal quality or condition factor of the FFFEs will be hampered with regard to its maximum potential accuracy and precision of prediction values.

Utilizing the AQS to neutralize and control for property conditions, creates the unique opportunity to isolate and predict with greater accuracy the location value and influence on a property rental rate or sale value. Then, by incorporating and calculating the discrete influence of both the AQS value for each property and the location value of each property, rental rates and property values can be predicted more accurately and more precisely. The method may further comprise assigning location values to each city block based upon actual rents and using multilinear regression, ML, or other statistical/geostatistical methods, parse the relative influences of AQS, location/city block, rentable area, property age, and other relevant factors to create one or more algorithms that could not be otherwise duplicated with equivalent accuracy without an AQS or equivalent/comparable component.

### Example

The following is a non-limiting example of the present invention. It is to be understood that said example is not intended to limit the present invention in any way. Equivalents or substitutes are within the scope of the present invention.

A user navigates to the frontend website hosting the application of the present invention on their Internet browser of choice. The user has several options that they can navigate to at this time. The user navigates to the market selection category on the website, which displays a map of a region with color-coded metropolitan statistical areas (MSAs). The user is able to select certain criteria to filter which MSAs are shown (e.g. net operating income (NOI), price, population growth of one or more age groups, rent growth, rent control, eviction time frames, absorption rate, projected supply/demand ratio vacancy, rental listing growth rates, etc.). The user is able to tweak the shapes of the MSAs into geoshapes distinguished by county, census tracts, block groups, blocks, etc. The map shows a plurality of selectable properties for sale. The user is able to click on a Data & Analytics tab that converts the map of selectable properties for sale into a non-scrapable sortable table view. MSAs are able to be sorted and filtered from the map and/or table view based on supply/demand trends, rent growth, population, employment rates, job growth, industry diversity, volatility, affordability, dwelling permits, etc. The default parameter for sorting MSAs is the overall predictive market score, calculated based on a backend machine learning algorithm combining a plurality of predictive factors into one score, based on historical time series data, indicative of likely rent growth. The MSAs displayed to the user are able to be selected, deselected, and stored for later analysis.

Upon selecting an MSA or geoshape, the website displays all 2+ unit properties for sale with markers and price labels. The user clicks on the Trends button which displays a visualization of historical rent growth against one or more predictors in the MSA or geoshape. The visualization is in the form of a line chart along a user-selected timeline of rent growth and the selected predictors (e.g. a machine-learning-assisted rent growth predictor). The user is able to zoom in to view all listed and unlisted 2+ multifamily properties. The user is able to zoom in further to view all listed prices and unlisted income-based value estimates. The user is able to toggle marker size, color, shape, and label options to represent different multifamily property metrics (e.g. square footage, cost per square foot, number of units, rental rate prediction, NOI, as-is value, value-add profit potential, etc.). The user is able to filter the properties for sale such that only subsets of multifamily properties are displayed (e.g. by number of units, price, loan maturity, motivation to sell factor, profit potential, amenities, etc.).

The user is able to toggle a background layer and heatmap options of the MSA or geoshape such that location value, building footprints, businesses, parks, price per square foot, satellite data, crime rate, insurance rates per square foot, or taxes per square foot, etc. are displayed. The background layer/heatmap can be displayed as a 3D mesh. The user is able to select 3D location values to view and navigate the 3D mesh representing location values as z values (residual after size and grade value subtraction), with individual property location values shown as spikes and holes. The user is able to select a 3D Opportunity Finder to view and navigate the 3D mesh representing inverse location values as z values (residual after size and grade value subtraction), to show individual properties renting substantially below the expected value as spikes. The z values above can be combined with other factors to affect the shape of the 3D mesh, such as motivation to sell (e.g. due to foreclosure, bankruptcy, death, probate, divorce, tax liens/arrears, loan maturity, etc.).

The user is able to draw and save a polygon on the MSA or geoshape to filter properties by a custom geographic boundary, with selected background layers togglable. The user is able to see and overwrite default global assumptions (e.g. cap rate, loan interest rate, expense ratio, default interior grade, etc.) visualized as an absolute value of difference or +/− compared to the predicted value. These global assumptions can be saved to the user's profile. The user is able to save any of the selection/search settings to their profile as a named search. The user is able to save any selected properties to the Saved Properties list on their profile. The user is able to sign up for email notifications of new listings or changes to the status in any of their saved searches or properties.

The user is able to hover over individual properties in the MSA/geoshape to see basic property data (e.g. square footage, number of units, rental rate prediction, owner, sales, rental history, etc.) and an image of the property. The user is able to click on the property (from the map view or analytics view) to view a Property Summary with pictures, predicted income, expenses, NOI, cashflow, value, value-add profit, owner-occupied scenarios, etc.). The user is able to visualize data of the property in the form of an area chart of equity growth over time with rate line graphs below demonstrating potential wealth-building power of investing in this property at assumed rates and values, adjustable by the user. The chart can be optimized for zero or positive cashflow with maximum value growth. Line graphs are shown beneath the area chart representing input assumptions over time and investment metrics like return on investment (ROI), cashflow, cash-on-cash, etc. over time. An additional red/greed cashflow graph is shown above or below the equity graph. From within the Property Summary, the user is able to click on the Deal Analyzer to further evaluate property revenue, expenses, NOI, cashflow, and value (as-is or as-if improved). The user is able to click on the Owner (or groups of owners in table view) to find True Owner Contact Info.

The user is able to identify listings with the highest AI-calculated profit potential at the listing or “whisper” price. The listings are identified with certain markers/symbols in the map view and are placed at the top of the list in the list view. The list view is sorted by profit potential. The user is able to identify off-market deals with the highest AI-calculated potential to purchase with maximum value-add profit. These deals are identified with certain markers/symbols in the map view and are placed at the top of the list in the list view. The user is able to continue to automatically identify and sort the highest profit potential deals as they are further evaluated with the Deal Analyzer.

The user is able to use a machine-learning-powered profit and cashflow calculator. The user inputs data into a form for pro forma revenue, expenses, debt service, and cashflow guided by AI-generated predicted default line item values and comparables, along with additional popup forms. The additional popup forms comprise a current and value-add features checklist, which affects the rent, operating expenses, improvement costs, and overall value. The additional popup forms further comprise improvement scope and cost estimate builder. The additional popup forms further comprise a rent analyzer with AI-sorted selectable comparables and predicted rents.

Within applicable pro forma line item expenses, the user is able to click on a variety of items to find and view ratings, reviews, credentials, and connect with applicable local multifamily service professionals suitable for the specific property and location. Clicking on Get Loan Quotes allows the user to find, qualify, and connect with multifamily lenders. Clicking on Get Insurance Quote allows the user to find, qualify, and connect with multifamily insurers. Clicking on Get Property Management Quote allows the user to find, qualify, and connect with property management companies. Clicking on Get Transaction/Tax Appeal Attorney Quote allows the user to find, qualify, and connect with a transaction/tax appeal attorney. Clicking on Get Contractor Quote in the improvement cost calculator allows the user to find, qualify, and connect with contractors.

The user is able to save the generated analyses and underwriting to their profile. The user is able to open and make changes to saved analyses and underwriting. The user is able to export pro forma expense forms to Excel®. The user is able to print out an underwriting report.

The user is able to publicly access the website without a login to view limited free information about renters, geographic information, etc. The user is able to create a free account with a login, profile, privacy settings, commenting functionality for communities and properties, access to hover information, and viewability for service provider ratings and reviews. The user is able to create an investor account with access to all features of the free account along with functionality for saving global, market, floorplan, and unit-level assumptions, claiming properties, making investment ownership reports available to selected sellers/brokers, advertising property types to individual or credentialed owners, advertising open offers (above a certain dollar amount) to individual or credentialed owners, advertising open bids for work needed to individual, credentialed, or highly-rated multifamily service providers, posting to market, topic, property, and personal threads, connecting with and getting endorsements from other investors, buyers, sellers, and professionals, and accessing and utilizing shareable cloud storage folders and deal rooms. The user is able to create a professional account for lenders, brokers, attorneys, contractors, inspectors, insurers, designers, construction managers, architects. The professional account comprises functionality for creating a professional profile, posting to market, topic, and property threads for visibility, getting recommended to multifamily investors based upon services offered, and adding a personal or company investor profile at a discounted rate.

This application is directed to a specific, computer-implemented method that transforms raw property transaction data into normalized, separable predictors through processor-performed regression, residual analysis, and structured data transformations. The steps recite processor-performed identification and construction of structured comparable datasets, automated normalization of size effects through regression between transaction price (or rent) and size, processor-calculated Appeal Quality Scale (AQS) values, processor-derived General AQS Value (GAV) from pairwise regression of residuals, regression of residuals on geographic coordinates and other predictor variables to compute location effects, differential adjustments across multiple normalized predictors, and algorithmic averaging of adjusted comparable values to generate a predicted rental rate or property value.

These steps form a multi-stage computational pipeline that transforms unstructured comparable transaction data into machine-generated predictor variables. This is not a generic evaluation of information but a precise algorithmic workflow that produces new, structured data not derivable through inspection or manual calculation. Each stage requires processor-executed mathematical operations on datasets that may include hundreds or thousands of transactions. These operations include regression of price or rental rate on size to isolate the size relationship, fitting best-fit curves for each comparable group, computing weighted averages of regression curves, calculating AQS scores from weighted feature values, deriving a GAV from aggregated residual relationships across comparable pairs, computing spatially-weighted residual contributions through kriging or inverse-distance weighting, performing differential adjustments across all predictor components, and recomputing final predictions when comparables are added or removed.

The present invention improves computer performance by transforming heterogeneous comparable data into normalized, algorithmically separable predictors, isolating size, feature, and location effects through multi-stage regression and residual modeling, reducing noise and inconsistency in comparable data, generating new intermediate machine-derived variables that enable accurate and explainable predictions, and enabling dynamic recalculation of predictions in response to changes in the comparable dataset.

The method is tied to a concrete real-world application for generating explainable rental rate or property value predictions for real properties, computing intermediate predictor variables not present in the input data, applying spatial modeling to residuals, producing valuation outputs used in underwriting, investment, and appraisal, and allowing iterative refinement through addition or removal of comparables. The computing device implementing the present method is specialized to automatically normalize size effects through regression, derive AQS and GAV values from weighted feature scoring and residual regression, compute location values through spatial residual modeling, isolate distinct components of value in a multi-stage algorithmic pipeline, recompute predictions dynamically based on adjusted comparable sets, and integrate the resulting predictors into valuation metrics and income models. The system uses the processor as an active computational engine executing interrelated algorithmic steps, not as a passive calculator. The invention likewise generates new intermediate data structures-including size-normalization curves, AQS scores, GAV values, residual-based location surfaces-which courts have held to be patent-eligible outputs. In general, the present invention features a specific, technological method that uses structured regression and residual modeling to isolate value components, generates new intermediate machine-derived predictors, materially improves the accuracy and consistency of computer-based valuation, applies the process to both rental and sales transactions, and produces a practical real-world valuation output.

The methods described herein can be performed by a computer system comprising a processor and a non-transient memory component operatively coupled to the processor. Accordingly, the steps of the methods described herein may be contained in the memory component as computer-readable instructions capable of being executed by the processor of the computer system. The computer system may further comprise a display component operatively coupled to the processor for steps that involve displaying data to a user. The computer system may further comprise components and functionality for accessing data on databases contained locally and/or on cloud servers.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth. The user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft® NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft® Corporation; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

In some embodiments, the figures presented in this patent application are drawn to scale, including the angles, ratios of dimensions, etc. In some embodiments, the figures are representative only and the claims are not limited by the dimensions of the figures. Reference numbers are solely for ease of examination of this patent application, and are exemplary, and are not intended in any way to limit the scope of the claims to the particular features having the corresponding reference numbers in the drawings.

In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A method, in a computer system having a processor, for calculating and displaying an explainable financial value prediction of one or more valuation subjects by isolating a plurality of financial value components of the valuation subject, the plurality of financial value components comprising location, size, and one or more physical features, the method comprising:
a. computationally identifying, from a database comprising data associated with a plurality of properties, a plurality of comparables, each comparable comprising a known financial value for each comparable, and a plurality of comparable financial value components, the plurality of comparable financial value components comprising location, size, and one or more physical features, the plurality of comparables comprising:
i. a first subset of comparables comprising two or more comparables having different sizes, and similar physical features and location; and
ii. a second subset of comparables comprising two or more comparables having different physical features, and similar size and location;
b. computationally adjusting, by the processor, for each comparable, the known financial values for time by generating a monthly market-value index from comparable known financial values within a given non-outlier range, and applying the monthly market-value index to the known financial values, resulting in time-adjusted financial values;
c. computationally quantifying, by the processor, an effect of size on financial value based on the time-adjusted first subset of comparables;
d. computationally determining, by the processor, for each comparable of the time-adjusted second subset of comparables, for each physical feature, a value and a weight, wherein the value is determined based on a quality of the feature, wherein the weight is determined based on an estimated percentage of which the feature contributes to an overall appeal of the comparable;
e. computationally calculating, by the processor, for each comparable of the time-adjusted second subset of comparables, an appeal quality scale (AQS) value;
f. computationally quantifying, by the processor, an effect of physical features on financial value based on the AQS values of the second subset of comparables;
g. grouping, by computer-generated clustering logic implemented on the processor, the plurality of comparables into location groups such that each location group is determined by an existing geographical subdivision, census-based geographic units, clusters exhibiting low variance in time-adjusted financial values, or a combination thereof;
h. computationally deriving, by the processor, for each location group, based on a regression of the effect of size on financial value and the effect of physical features on financial value, an effect of location on financial value, resulting in a fitted curve;
i. computing, by the processor, for each location group, residual values by dividing the time-adjusted financial values by predicted prices derived from the fitted curve;
j. computationally determining, by the processor, based on the residual values, upper and lower percentile-based residual bands representing a range of prices; and
k. computationally calculating, by the processor, based on a size of the one or more valuation subjects, one or more physical features of the one or more valuation subjects, a location of the one or more valuation subjects, the fitted curve, and the upper and lower percentile-based residual bands, a predicted financial value between the upper and lower percentile-based residual bands of at least one of the one or more valuation subjects.

2. The method of claim 1, wherein the plurality of comparable financial value components further comprise one or more additional characteristics;
wherein the plurality of comparables further comprises a fourth subset of comparables comprising two or more comparables having different additional characteristics, and similar size, physical features, and location;
wherein the method further comprises quantifying, by the processor, an effect of additional characteristics on financial value based on the fourth subset of comparables;
wherein calculating the predicted financial value is further based on the effect of additional characteristics on financial value and one or more additional characteristics of the one or more valuation subjects; and
wherein quantifying the effect of additional characteristics on financial value comprises, for each additional characteristic of the one or more additional characteristics, measuring and averaging differences in financial values relative to differences in the additional characteristic within one or more groupings of comparables within the fourth subset of comparables;
wherein the one or more additional characteristics comprise age, form and quality of property management, maintenance, customer service, offered resident services, communication quality and channels between residents and property management, advertising, marketing, sales practices, pricing strategy, promotions, retention programs, concessions, resident rewards programs, quantitative and qualitative measures of online reviews, ratings and presence among internet rental or sales listing sites or advertising sites, or a combination thereof.

3. The method of claim 1, wherein quantifying the effect of size on financial value comprises:
a. calculating, by the processor, for each comparable of the first subset of comparables, a financial value per square foot value based on the size and the known financial value of each comparable of the plurality of comparables;
b. calculating, by the processor, a best-fit equation for two or more comparables of the first subset of comparables relating the financial value per square foot value to the size; and
c. calculating, by the processor, an average best-fit equation approximating a weighted average of the best-fit equations for the comparables of the first subset of comparables, wherein a weight of each best-fit equation of each comparable is based on a number of comparables from which each best-fit equation is derived;
wherein the effect of size on financial value is calculated by inputting the size of each valuation subject of the at least one of the one or more valuation subjects into the average best-fit equation.

4. The method of claim 1, wherein determining, for each comparable of the second subset of comparables, for each physical feature, the value comprises analyzing one or more images of the physical feature by human analysis, computer vision, or a combination thereof.

5. The method of claim 1, wherein quantifying an effect of physical features on financial value comprises:
a. selecting, by the processor, a pair of comparables r1 and r2 within a comparable of the second subset, such that an AQS value of r1, AQS1, is less than an AQS value for r2, AQS2;
b. calculating, by the processor, intermediate predicted financial values for r1 and r2 based on the effect of size on financial value;
c. subtracting, by the processor, the intermediate predicted financial value for r1 from the known financial value of r1, resulting in a difference d1;
d. subtracting, by the processor, the intermediate predicted financial value for r2 from the known financial value of r2, resulting in a difference d2;
e. calculating, by the processor, a rate of change in financial value with respect to a change in AQS value, by subtracting d1 from d2, resulting in a difference d3, and dividing d3 by a difference resulting from subtracting AQS1 from AQS2, resulting in a value of financial value per AQS value;
f. repeating steps a-e for each pair of comparables of each comparable of the second subset;
g. averaging, by the processor executing pairwise residual analysis, the values of financial value per AQS value for each pair of comparables of each comparable of the second subset, resulting in a General AQS Value (GAV), wherein the GAV represents an estimated additional value contributed to comparable financial value if a comparable was completely updated as compared to if the comparable was completely outdated;
h. averaging, by the processor, the AQS values of the comparables of the second subset of comparables, resulting in an average AQS value; and
i. calculating, by the processor, based on the GAV, the average AQS value, and the AQS value of the at least one of the one or more valuation subjects of the valuation subject, the effect of physical features on financial value.

6. The method of claim 1, wherein deriving the effect of location on financial value comprises:
a. predicting, by the processor, intermediate financial value for each comparable based on the effect of size on financial value, and the effect of physical features on financial value;
b. measuring, by the processor, for each comparable, a residual error by calculating a difference of the intermediate financial value from the known financial value;
c. storing, by the processor, for each comparable, the residual error and location coordinates of the comparable in a structured data format;
d. incorporating, by the processor, for each comparable, one or more additional predictor variables to the structured data format, the one or more additional predictor variables comprising economic data of an area surrounding the location, demographic data of the area surrounding the location, crime rates of the area surrounding the location, familial status data of the area surrounding the location, distance from the location to one or more key locations of interest, or a combination thereof; and
e. applying, by the processor, one or more spatial modeling and geostatistical algorithms to the structured data format to determine the effect of location on financial value, the one or more spatial modeling and geostatistical algorithms comprising kriging, inverse-distance weighting, or a combination thereof.

7. The method of claim 1, wherein calculating the predicted financial value of the at least one of the one or more valuation subjects of the valuation subject comprises:
a. applying, for each comparable relative to the valuation subject, for each comparable financial value component of the plurality of comparable financial value components, a differential value based on the comparable financial value component compared to a corresponding financial value component of the valuation subject;
b. summing, for each comparable, the differential values of the plurality of comparable financial value components resulting in a sum of differential values;
c. adding, for each comparable, the sum of differential values to the known financial value of the comparable, resulting in an intermediate predicted financial value for the valuation subject based upon the comparable; and
d. calculating an average of the plurality of intermediate predicted financial values resulting in the predicted financial value of the at least one of the one or more valuation subjects of the valuation subject.

8. The method of claim 7 further comprising:
a. adding the predicted financial value to the database;
b. comparing the predicted financial value to the known financial values of the plurality of comparables and an effect of each financial value component on financial values; and
c. iteratively adjusting the effect of each financial value component on financial values such that a difference between the predicted financial value and the known financial values is minimized.

9. The method of claim 7, wherein the predicted financial value of the at least one of the one or more valuation subjects of the valuation subject is further based on a manual adjustment from a user, wherein the manual adjustment comprises an addition of value or a subtraction of value applied to an intermediate predicted financial value of the plurality of intermediate predicted financial values, the predicted financial value, or a combination thereof, selection or deselection of one or more intermediate predicted financial values of the plurality of intermediate predicted financial values from calculating the average, filtering the plurality of comparables by the plurality of comparable financial value components, or a combination thereof.

10. The method of claim 7 further comprising displaying, by the processor, the plurality of comparables on a display component such that the plurality of comparables are sorted into a list such that comparables most similar to the valuation subject are earlier in the list by a sorting method comprising:
a. calculating, for each comparable financial value component of a comparable, a differential value based on the comparable financial value component compared to a corresponding financial value component of the valuation subject and an effect of the corresponding financial value component on financial value;
b. summing an absolute value of each differential value into a sum of absolute differences;
c. repeating steps a-b for each comparable of the plurality of comparables; and
d. sorting the plurality of comparables by the sum of absolute differences of each comparable, wherein the list comprises the plurality of comparables.

11. The method of claim 1 further comprising displaying, by the processor, the plurality of comparables on a display component such that the plurality of comparables are filtered, sorted, or a combination thereof by a number of physical features.

12. The method of claim 1 further comprising calculating, by the processor, a predicted net operating income of the valuation subject, wherein calculating the predicted net operating income comprises:
a. calculating, by the processor, for each valuation subject of the valuation subject, the predicted financial value;
b. adding, by the processor, the predicted financial value of each valuation subject, resulting in a gross rents value;
c. subtracting, by the processor, a percentage of the gross rents value representing estimated loss to lease, vacancy, concessions, delinquency, or a combination thereof;
d. adding a percentage of the gross rents value representing additional sources of revenue including estimated utility reimbursements, equipment rentals, pet rents and deposits, parking revenue, application fees, collections, late charges, lease break fees, or a combination thereof to the gross rents value, resulting in an effective gross income value;
e. estimating, by the processor, based on the location of the valuation subject, a tax expense for the valuation subject;
f. estimating, by the processor, based on insurance data of the plurality of comparables, an insurance expense for the valuation subject;
g. estimating, by the processor, a payroll expense for the valuation subject;
h. estimating, by the processor, a utility expense for the valuation subject;
i. estimating, by the processor, a repair and maintenance expense for the valuation subject;
j. estimating, by the processor, a property management fee expense for the valuation subject;
k. estimating, by the processor, an advertising, marketing and administrative expense for the valuation subject; and
l. calculating, by the processor, based on the effective gross income, the tax expense, the insurance expense, the payroll expense, the utility expense, the repair and maintenance expense, the property management fee expense, and the advertising, marketing and administrative expense, the predicted net operating income of the valuation subject.

13. The method of claim 12 further comprising calculating, by the processor, a revised predicted net operating income and a predicted project cost associated with one or more hypothetical value-adding improvements to the at least one valuation subject, wherein calculating the revised predicted net operating income and a predicted project cost comprises:
a. calculating, by the processor, based on the effect of physical features on financial value and known operating expense values, a revised estimated net operating income for the valuation subject as a result of an addition of the one or more hypothetical value-adding improvements not present in the at least one valuation subject of the one or more valuation subjects;
b. calculating, by the processor, for each hypothetical value-adding improvements of the one or more hypothetical value-adding improvements, a construction cost comprising a cost of materials, a cost of labor, a cost of design, a cost of permitting, a cost of utilities, a cost of insurance, and a cost of non-revenue producing time of the at least one valuation subject during construction; and
c. calculating, by the processor, based on an added value of the one or more hypothetical value-adding improvements and the construction cost of each hypothetical value-adding improvements of the one or more new physical features, the revised predicted net operating income and the predicted project cost.

14. The method of claim 13 further comprising calculating, by the processor, a predicted loan rate of the valuation subject, wherein calculating the predicted loan rate comprises:
a. estimating, by the processor, based on a set of current market data from a market data database, a size of a loan likely to be approved for the valuation subject;
b. estimating, by the processor, based on the set of current market data, an interest rate of the loan;
c. estimating, by the processor, based on the set of current market data, a term and amortization schedule for the loan;
d. estimating, by the processor, based on the set of current market data, a frequency of payments of the loan;
e. estimating, by the processor, based on the set of current market data, fees of the loan; and
f. calculating, by the processor, based on the size of the loan, the interest rate, the term and amortization schedule, the frequency of payments, and the loan fees, the predicted loan rate of the valuation subject.

15. The method of claim 14 further comprising calculating, by the processor, with and without the one or more hypothetical value-adding improvements, one or more predicted property valuation metrics including a predicted pro forma revenue, one or more expense line items, gross rents, effective gross income, operating expenses, operating expense ratio, net operating income, gross rent multiplier, capitalization rate, estimated resale value, loan to value ratio, debt service coverage ratio, yield on cost, debt service, cashflow, total project cost, profit potential, maximum recommended offer amount, price per square foot, return on investment, cash-on-cash return, internal rate of return or a combination thereof.

16. The method of claim 15 further comprising filtering, sorting, stratifying or classifying, by the processor, the valuation subject, one or more comparables of the plurality of comparables, or a combination thereof, according to one or more predicted property valuation metrics, and displaying representations of the valuation subject, the one or more comparables of the plurality of comparables, or the combination thereof with markers or labels of different colors, shapes, sizes, or a combination thereof corresponding to different ranks, tiers or classes of properties in a mapped, graphical, or tabular form.

17. The method of claim 15 further comprising tracking and calculating valuation metrics of the valuation subject, the one or more comparables of the plurality of comparables, or the combination thereof upon detecting the valuation subject, the one or more comparables of the plurality of comparables, or the combination thereof listed on internet listing sites, and providing alerts when at least one of one or more predicted property valuation metrics of the valuation subject, the one or more comparables of the plurality of comparables, or the combination thereof matches user preferences related to at least one valuation metric of the plurality of valuation metrics.

18. The method of claim 15 further comprising calculating, by the processor, predicted debt, equity and cashflow growth values over time for the valuation subject, the one or more comparables of the plurality of comparables, or the combination thereof, and displaying the predicted debt, equity and cashflow growth values over time in a graphical format, the graphical format comprising a line or stacked area chart, on a display component.

19. The method of claim 1, wherein determining the value of the physical features of a comparable comprises:
a. receiving a plurality of images of an interior of the comparable;
b. classifying each image into a scene category using a trained neural classifier;
c. detecting, within each classified image, components relevant to property condition using an object-detection model;
d. segmenting regions corresponding to detected components using a segmentation model conditioned on component class;
e. classifying each segmented component into a material or condition category using a trained classifier;
f. generating component-level condition scores using consolidation rules applied across the classified images; and
g. producing the value of the physical features by weighting the component-level scores according to component-specific contribution parameters.

20. The method of claim 1 further comprising interactively visualizing property valuations, comprising:
a. rendering, on a client device, a scatterplot of financial values versus size, the scatterplot comprising percentile-based curves;
b. receiving user selections or user-defined filters applied to the transactions; and
c. recomputing, on the client device, at least one of a lower band, central-tendency band, or upper band of financial values using curve parameters transmitted to the client and updating the scatterplot accordingly.
